(19) United States
(12) Patent Application Publication
(10) Pub. No.: US 2012/0172251 A1
(43) Pub. Date: Jul. 5, 2012

(54) METHODS AND COMPOSITIONS FOR DIAGNOSING HEART FAILURE

(75) Inventor: Brian D. Lowes, Denver, CO (US)

(73) Assignee: The Regents of the University of Colorado, a body corporate, Denver, CO (US)

(21) Appl. No.: 13/395,655

(22) PCT Filed: Sep. 16, 2010
(86) PCT No.: PCT/US2010/049103

§ 371 Date: Mar. 13, 2012

(51) Int. Cl. C40B 30/04; C40B 40/06

(52) U.S. Cl. 506/9; 506/16

(57) ABSTRACT

The present invention provides diagnostic and prognostic assays and kits for determining whether a heart failure patient will respond to a pharmacotherapy. Methods of the invention include determining the expression level of biomarkers that are differentially expressed in a heart failure patient that responds to a pharmacotherapy compared to a heart failure patient that does not respond to a pharmacotherapy.

### CROSS-REFERENCE TO RELATED APPLICATIONS

This application claims the priority benefit of U.S. Provisional Application No. 61/243,126, filed Sep. 16, 2009, which is incorporated herein by reference in its entirety.

### STATEMENT REGARDING FEDERALLY FUNDED RESEARCH

This invention was made with government support under grant number K23-HL068875 awarded by the National Institutes of Health. The government has certain rights in the invention.

### FIELD OF THE INVENTION

The present invention is generally related to diagnostic and prognostic assays and kits for determining whether a heart failure patient will respond to a pharmacotherapy. The invention includes the identification and use of biomarkers that are differentially expressed in a heart failure patient that responds to a pharmacotherapy compared to a heart failure patient that does not respond to a pharmacotherapy.

### BACKGROUND OF THE INVENTION

Heart failure is associated with poor quality of life, frequent hospitalizations, and a high mortality, and it is increasingly prevalent in Western society. The disease is typically characterized by a loss in systolic function, ventricular dilation, increased chamber sphericity, wall thinning, and mitral regurgitation. This remodeling is associated with adverse outcomes, including increased mortality. Beta-blockers, which form the cornerstone of contemporary medical therapy for heart failure, have been shown to improve ejection fraction, while decreasing left ventricular (LV) mass, chamber sphericity, and mitral regurgitation. The net effect of beta-blocker therapy in heart failure patients is an improvement in survival, quality of life, and hospitalizations. This improvement in survival on beta blockade is attributable to a decrease in arrhythmic as well as pump failure deaths.

The present inventor has evaluated molecular mechanisms of beta-blocker response in dilated cardiomyopathy patients using chronic cardiac remodeling as a surrogate marker for response to therapy. An improvement in ejection of 5% was classified as responding to therapy. Patients who did not improve to this degree on beta-blockers had poor long term response, and the present inventor has observed that typically about 20% of patients with idiopathic dilated cardiomyopathies (IDCM) did not respond to optimal medical therapy. These patients often require complex interventions such as implantable defibrillators, artificial hearts, or cardiac transplantation. These therapies are expensive and, in the case of cardiac transplantation, difficult to obtain due to donor limitations.

Current guidelines utilize left ventricular systolic function as the biomarker to select patients for prophylactic implantable cardioverter defibrillators (ICDs). Recommendations from the American Heart Association, the American College of Cardiology and the Heart Failure Society of America all suggest that patients should be evaluated at three months post-initiation of medical therapy for new onset heart failure. There are some major limitations to this approach. For example, β-blockers have been shown to produce dose related improvements in cardiac function. In addition, even at three months many patients are not receiving optimal doses of medical therapy. Furthermore, improvement in systolic function on β-blocker therapy is time dependent, as such maximal improvement in systolic function in many patients does not occur until about 6 to 12 months after the initiation of β-blocker therapy. The present inventor has observed that typically at 3 months only about 50% of patients could be classified as responders (e.g., improvement in LVEF by 5 EF units), whereas at 12 months about 80% of patients had responded to medical therapy. At 90 days post-heart failure hospitalization, less than 10% of patients are receiving recommended doses of β-blockade. Unfortunately, patients who don't respond to pharmacotherapy, who would benefit the most from device therapy and/or consideration of mechanical support and/or transplant, often receive these interventions too late, typically after their disease has progressed or they have developed a morbid complication.

The net result of current guidelines is that many patients receive devices that they will never use or need. Currently, ICD implantation costs range from $28,500 to $55,200 (in 2006 United States dollars), with annual follow-up costs ranging from $4,800 to $17,000. In Sudden Cardiac Death in Heart Failure Trial (SCD-HeFT), the annual reduction in mortality with ICD therapy was only 1.4% per year. This means that it is necessary to treat 14 patients over 5 years to save one life. The cost per year of life saved is tremendous. While cardiac transplantation and artificial heart hearts are also effective therapies, their costs are also quite high.

Therefore, there is a need for a method for determining which patients would benefit from these therapies.

### SUMMARY OF THE INVENTION

Various methods of the invention utilize a group of biomarkers for determining whether a particular heart failure patient (e.g., congestive heart failure patient) is responsive or non-responsive to a pharmacotherapy (e.g., β-blocker treatment). It should be appreciated that the invention involves analyzing at least ten biomarker genes, typically at least twenty, often at least fifty, and more often at least sixty, biomarker genes. As is the case in majority of instances, a single gene is insufficient to predict, determine, or diagnose a disease with a sufficient specificity and selectivity. This is particularly true in the case of heart failure which can have a wide variety of factors and causes. In fact, it has been discovered by the present inventor that in order to determine, with an acceptable specificity and selectivity, whether a heart failure patient will respond to a pharmacotherapy, at least ten, typically at least twenty, often at least fifty, and more often at least sixty, biomarker genes need to be analyzed. Less than these amounts of biomarker gene analysis in methods of the invention lead to clinically useless procedures.

Some aspects of the invention provide methods for determining whether a congestive heart failure patient will respond to a pharmacotherapy treatment. This information can be used to determine the course of treatment for that particular patient. Typically, such methods include:
determining the expression level of at least ten selected biomarker genes from a biological sample obtained from a congestive heart failure patient, wherein the selected biomarker genes are chosen from a panel of standard biomarker genes that are upregulated or downregulated in a heart failure patient that responds to the pharmacotherapy compared to a heart failure patient that does not respond to the pharmacotherapy,
   wherein if the expression level of the selected biomarker genes in the biological sample of the patient is statistically more similar to the expression level of the biomarker genes that has been associated with the heart failure patient that responds to the pharmacotherapy than the expression level of the biomarker genes that has been associated with the heart failure patient that does not respond to the pharmacotherapy, then the result is indicative that the patient responds to the pharmacotherapy.

In some embodiments, the panel of standard biomarker genes comprises AGK, BCL2L13, COQ10B, HIF1AN, PPM1D, SPCS3, TBL1XR1, TBX2, TMEM139, UBE2B, ATP6V1B2, ATRNL1, C10orf88, CAPZA2, CASQ1, CDK5R1, CENPQ, CETP, COX8A, DGAT1, ERCC4, ERF, FPGT, GLS, IRF2, LEMD3, MAGEE1, ME2, MSX2, NHEDC2, NUFIP2, PABPC1L, PCDHB15, PDIA6, PHF2, PLEKHA3, PPIC, PRPF38B, RAP2B, RBM12B, RFXAP, ROBO4, SMAD4, SMNDC1, SOAT1, SPINT2, TM2D1, VTN, WDR44, XPNPEP3, ZNF704, ADRB1, ANKIB1, ARHGEF15, ARMC1, ASXL2, ATP6V1A, BBS10, BET1, BHLHE40, Cl4orf21, C16orf87, Clorf55, C2orf37, C5orf22, C6orf59, CA3, CASD1, CTDSPL2, EDEM3, EGLN3, EPB41L5, ERO1L, FAM117B, FAM26E, GALNTL1, GIPC2, HK2, HOXD3, HPRT1, IMMP1L, ISCA1, KCNJ2, KDSR, KIAA0562, KIAA0802, LOC148189, LRRC40, LYRM5, MEX3C, MRPS25, NDFIP1, NETO2, PLN, SLAIN2, SLC16A7, SLC17A5, SPATA5, TMEM19, TMEM65, UGDH, UNC5B, ZBTB44, ZC3H12C, ZCCHC2, ZDBF2, ZNF404, and ZNF791. Often the selected biomarker genes comprise at least ten of the standard biomarker genes listed above. In some embodiments, the selected biomarker genes comprise at least twenty, typically at least fifty, and often at least sixty, of the standard biomarker genes listed above.

In other embodiments, the selected biomarker genes comprise AGK, BCL2L13, COQ10B, HIF1AN, PPM1D, SPCS3, TBL1XR1, TBX2, TMEM139, UBE2B, or a combination thereof. Often, the selected biomarker genes comprise all of the following genes: AGK, BCL2L13, COQ10B, HIF1AN, PPM1D, SPCS3, TBL1XR1, TBX2, TMEM139, and UBE2B.

Yet in other embodiments, the selected biomarker gene further comprises ATP6V1B2, ATRNL1, C10orf88, CAPZA2, CASQ1, CDK5R1, CENPQ, CETP, COX8A, DGAT1, ERCC4, ERF, FPGT, GLS, IRF2, LEMD3, MAGEE1, ME2, MSX2, NHEDC2, NUFIP2, PABPC1L, PCDHB15, PDIA6, PHF2, PLEKHA3, PPIC, PRPF38B, RAP2B, RBM12B, RFXAP, ROBO4, SMAD4, SMNDC1, SOAT1, SPINT2, TM2D1, VTN, WDR44, XPNPEP3, ZNF704, or a combination thereof. In some instances, the selected biomarker genes comprise at least ten, typically at least forty, and often at least fifty genes listed above.

Still in other embodiments, the selected biomarker gene further comprises ADRB1, ANKIB1, ARHGEF15, ARMC1, ASXL2, ATP6V1A, BBS10, BET1, BHLHE40, Cl4orf21, C16orf87, Clorf55, C2orf37, C5orf22, C6orf59, CA3, CASD1, CTDSP12, EDEM3, EGLN3, EPB41L5, ERO1L, FAM117B, FAM26E, GALNTL1, GIPC2, HK2, HOXD3, HPRT1, IMMP1L, ISCA1, KCNJ2, KDSR, KIAA0562, KIAA0802, LOC148189, LRRC40, LYRM5, MEX3C, MRPS25, NDFIP1, NETO2, PLN, SLAIN2, SLC16A7, SLC17A5, SPATA5, TMEM19, TMEM65, UGDH, UNC5B, ZBTB44, ZC3H12C, ZCCHC2, ZDBF2, ZNF404, ZNF791, or a combination thereof. In some embodiments, the selected biomarker genes comprise at least ten genes listed above.

In some embodiments, the expression level of at least twenty selected biomarker genes are determined and compared to the control expression level. In other embodiments, the expression level of at least fifty selected biomarker genes are determined and compared to the control expression level. Still in other embodiments, the expression level of at least sixty selected biomarker genes are determined and compared to the control expression level.

Some methods of the invention comprise determining the expression level of mRNA of the selected biomarker genes. In some embodiments, methods of the invention can further include determining the expression level of micro RNA (miRNA) that inhibits or accelerates translation mRNA. In some instances, the miRNA comprises miRNA-1, miRNA-21, miRNA-29, miRNA-133a, miRNA-133b, miRNA-150, miRNA-195, miRNA-208, or a combination thereof.

Still in other embodiments, methods of the invention can include determining the ratio of expression levels of mRNA and miRNA.

Some methods of the invention can further include determining the amount of protein produced by the selected biomarker gene.

Often the sample comprises an endomyocardial biopsy sample of the patient.

Yet other aspects of the invention provide microarrays comprising a plurality of oligonucleotides that are capable of detecting expression level of at least ten biomarker genes selected from the group consisting of AGK, BCL2L13, COQ10B, HIF1AN, PPM1D, SPCS3, TBL1XR1, TBX2, TMEM139, UBE2B, ATP6V1B2, ATRNL1, C10orf88, CAPZA2, CASQ1, CDK5R1, CENPQ, CETP, COX8A, DGAT1, ERCC4, ERF, FPGT, GLS, IRF2, LEMD3, MAGEE1, ME2, MSX2, NHEDC2, NUFIP2, PABPC1L, PCDHB15, PDIA6, PHF2, PLEKHA3, PPIC, PRPF38B, RAP2B, RBM12B, RFXAP, ROBO4, SMAD4, SMNDC1, SOAT1, SPINT2, TM2D1, VTN, WDR44, XPNPEP3, ZNF704, ADRB1, ANKIB1, ARHGEF15, ARMC1, ASXL2, ATP6V1A, BBS10, BET1, BHLHE40, Cl4orf21, C16orf87, Clorf55, C2orf37, C5orf22, C6orf59, CA3, CASD1, CTDSPL2, EDEM3, EGLN3, EPB41L5, ERO1L, FAM117B, FAM26E, GALNTL1, GIPC2, HK2, HOXD3, HPRT1, IMMP1L, ISCA1, KCNJ2, KDSR, KIAA0562, KIAA0802, LOC148189, LRRC40, LYRM5, MEX3C, MRPS25, NDFIP1, NETO2, PLN, SLAIN2, SLC16A7, SLC17A5, SPATA5, TMEM19, TMEM65, UGDH, UNC5B, ZBTB44, ZC3H12C, ZCCHC2, ZDBF2, ZNF404, and ZNF791.

In some embodiments, such microarrays are capable of detecting the expression of at least twenty, typically fifty, and often sixty biomarker genes.

Yet in other embodiments, microarrays of the invention are capable of detecting the expression level of biomarker genes comprising AGK, BCL2L13, COQ10B, HIF1AN, PPM1D, SPCS3, TBL1XR1, TBX2, TMEM139, UBE2B, or a combination thereof. Often all of the listed biomarker genes can be detected by microarrays of the invention. As used herein, the term “microarray” refers to any ordered sets of oligonucleotides of known sequence. Each individual feature goes on the array at precisely defined location on the substrate. Exemplary microarray include a 2D array, typically on a glass, filter, micro-wells, or silicon wafer, upon which oligonucleotides are attached or synthesized in a predetermined spatial order allowing them to be made available as probes in a high-throughput, parallel manner.

Still in other embodiments, microarrays are further capable of detecting the expression level of biomarker genes comprising ATP6V1B2, ATRNL1, C10orf88, CAPZA2, CASQ1, CDK5R1, CENPQ, CETP, COX8A, DGAT1, ERCC4, ERF, FPGT, GLS, IRF2, LEMD3, MAGEE1, ME2, MSX2, NHEDC2, NUFIP2, PABPC1L, PCDHB15, PDIA6, PHF2, PLEKHA3, PPIC, PRPF38B, RAP2B, RBM12B, RFXAP, ROBO4, SMAD4, SMNDC1, SOAT1, SPINT2, TM2D1, VTN, WDR44, XPNPEP3, ZNF704, or a combination thereof.

Yet in other embodiments, microarrays are further capable of detecting the expression level of biomarker genes comprising ADRB1, ANKIB1, ARHGEF15, ARMC1, ASXL2, ATP6V1A, BBS10, BET1, BHLHE40, Cl4orf21, C16orf87, Clorf55, C2orf37 C5orf22, C6orf59, CA3, CASD1, CTDSPL2, EDEM3, EGLN3, EPB41L5, ERO1L, FAM117B, FAM26E, GALNTL1, GIPC2, HK2, HOXD3, HPRT1, IMMP1L, ISCA1, KCNJ2, KDSR, KIAA0562, KIAA0802, LOC148189, LRRC40, LYRM5, MEX3C, MRPS25, NDFIP1, NETO2, PLN, SLAIN2, SLC16A7, SLC17A5, SPATA5, TMEM19, TMEM65, UGDH, UNC5B, ZBTB44, ZC3H12C, ZCCHC2, ZDBF2, ZNF404, ZNF791, or a combination thereof.

### BRIEF DESCRIPTION OF THE DRAWINGS

FIGS. 1A and 1B show miRNA expression profiles in samples obtained from non-failing (NF), idiopathic cardiomyopathy (IDC) and ischemic (ISC) patients. FIG. 1A is a graph showing relative expression of miRNAs at the log base 2 ratio of failing (F)/nonfailing (NF). NF vs. IDC, NF vs. ISC. Only miRNAs with a p<0.10 as determined by t-Test are shown. FIG. 1B is a bar graph showing the relative expression of a subset of miRNAs.

FIGS. 2A and 2B are graphs showing overexpression of miR-100 and miR-133 mimics, respectively, and inhibitors. miR mimic and inhibitor were transfected into NRVMs and their ability to affect changes in ISO-mediated changes in FGP expression patterns was evaluated.

FIG. 3 is a bar graph showing over-expression or down-regulation of miRNA-133b in NRVMs regulates cellular hypertrophy. Cells were transfected with miR-133 mimic or inhibitors and cell surface area was quantified. Cell size was measured using NIH “Image J” software. Inhibition of miR-133 expression enhances ISO-mediated myocyte hypertrophy whereas a mimic of miR-133 attenuates ISO-mediated hypertrophy. White bars, control. Black bars, ISO treatment.

FIG. 4 is a graph showing effects of MI on miR expression over time. Relative miR abundance was determined by RT-PCR. Fold change in miR expression for the MI group was compared to the sham operated control group. Values for the sham group were normalized to “1”. For each group at each time, n =2-4. Data are represented as X +/−SEM.

FIG. 5 is a schematic illustration of bioinformatic filtering process of assessing co-variate expression of miRNAs and mRNAs.

### DETAILED DESCRIPTION OF THE INVENTION

Cardiomyopathy relates to the deterioration of the cardiac muscle of the heart wall. The most common form is dilated cardiomyopathy wherein the heart, particularly the left ventricle, is enlarged and weakened. Often the cause is unknown. This is referred to as idiopathic dilated cardiomyopathy (IDC). IDC and other forms of cardiomyopathy can lead to heart failure, which is a debilitating condition in which abnormal function of the heart leads to inadequate blood flow to fulfill the needs of the tissues and organs of the body. Typically, the heart loses propulsive power because the cardiac muscle loses capacity to stretch and contract. Often, the ventricles do not adequately fill with blood between heartbeats and the valves regulating blood flow become leaky, allowing regurgitation or back-flow of blood. The impairment of arterial circulation deprives vital organs of oxygen and nutrients. A particularly severe form of heart failure is congestive heart failure (CHF) wherein the weak pumping of the heart leads to build-up of fluids in the lungs and other organs and tissues. CHF is often fatal. Hence, cardiomyopathy increases the risk of mortality since it can lead to heart failure. In addition, cardiomyopathy can trigger various life-threatening arrhythmias such as ventricular fibrillation, which can result in sudden cardiac death.

Contemporary pharmacologic therapy with beta adrenergic and angiotensin receptor blockade is often quite effective in preventing and even reversing CHF progression; however, it is difficult to predict which patients will and will not respond to therapy. This issue is particularly important because current therapeutic algorithms include the broad implementation of costly interventions, such as automatic implantable cardioverter defibrillator (AICD) implantation, despite the fact that less than 10% of recipients (and a far smaller percentage of those who respond to pharmacotherapy) will develop life-threatening arrhythmias and benefit from device therapy. Moreover, the subset of patients who don't respond to pharmacotherapy might truly benefit from device therapy and/or consideration of mechanical support and/or transplant but often receive these interventions too late, after their disease has progressed or they have developed a morbid complication. Ejection fraction, functional capacity and multivariate heart failure “scores” have been utilized to guide clinical decisions, but have poor predictive values for disease progression.

One aspect of the present invention provides methods for determining whether a heart failure patient will respond to a pharmacotherapy. Such methods can be used to determine an appropriate treatment for the patient, e.g., pharmacotherapy, implantable defibrillators, artificial hearts, or cardiac transplantation. If the patient is determined to be not responsive to a pharmacotherapy, such a patient would benefit from device therapy and/or consideration of mechanical support and/or transplant. As used herein, the term “pharmacotherapy” refers to treating a heart failure patient with a medication, e.g., with β-adrenergic and angiotensin receptor blocker (i.e., β-blocker).

Beta-blockers are known to improve myocardial function, decrease arrhythmias and improve survival in patients with heart failure. The molecular mechanisms by which beta blockers improve survival are poorly understood. Utilizing endomyocardial biopsies from the intact human heart, the present inventor has discovered a pattern of gene expression that predicts which patients will deteriorate. This discovery can be utilized in a variety of applications including, but not limited to, guiding individual patient decisions involving therapy with defibrillators, artificial hearts and cardiac transplantation.

Beta Blocker on Remodeling and Gene Expression (BORG) trial conducted by the present inventor showed that molecular profiling coupled with proteomic and genomic analyses of endomyocardial biopsy tissue offer a predictive tool that allows for the early identification of patients who will and will not respond to pharmacotherapy. A predictive algorithm was developed from the analysis of patients with dilated cardiomyopathy (DCM) who have undergone serial endomyocardial biopsies before and after initiation of beta-blocker therapy. Outcome was based on the combined endpoint of cardiac death, transplant, life threatening arrhythmia, placement of a ventricular assist device, or failure of LVEF (left ventricular ejection fraction) to improve on beta blocker (delta LVEF<5%) at one year. In some embodiments of the invention, the algorithm is based on one or more of the following: (i) mRNA profiling; (ii) miRNA array data evaluating specific miRNAs that influence myocardial gene profiles; cross-correlation and co-regulation of miRNAs and mRNAs; and (iii) quantitative proteomic assays targeting protein changes that have been shown to predict and define stage-specific adaptations to pathologic pressure overload.

In one particular embodiment, the use of microarray, miRNA, and proteomic analysis on human endomyocardial biopsy tissue resulted in the selection of complementary RNA and protein biomarkers. A predictive algorithm using these biomarkers represents the first multiplexed in vivo molecular diagnostic of the human heart. An improvement in ejection of 5% (e.g., after 1 year of beta-blocker pharmacotherapy) was classified as responding to therapy. Typically, patients who do not improve to this degree on beta-blockers have poor long term response, and studies by the present inventor showed that about 20% of patients with idiopathic dilated cardiomyopathies (IDCM) do not respond to medical therapy. These patients often require complex interventions such as implantable defibrillators, artificial hearts, or cardiac transplantation.

Some embodiments of the invention comprise determining the expression level of at least ten selected biomarker genes in a sample obtained from a biological sample obtained from the patient. The selected biomarker genes are chosen from a panel of standard biomarker genes that are upregulated or downregulated in a heart failure patient that responds to the pharmacotherapy compared to a heart failure patient that does not respond to the pharmacotherapy. In general any gene that has a different expression level between the patient that responds to the pharmacotherapy and the patient that does not respond to the pharmacotherapy can be used. One skilled in the art having the present disclosure can readily identify such genes. It should be recognized that the greater the difference in the expression level of the biomarker gene between the patient that responds to the pharmacotherapy and the patient that does not respond to the pharmacotherapy, the more significant the expression value. Typically, if the expression level of the selected biomarker genes in the biological sample of the patient is statistically more similar to the expression level of the biomarker genes that has been associated with the heart failure patient that responds to the pharmacotherapy than the expression level of the biomarker genes that has been associated with the heart failure patient that does not respond to the pharmacotherapy, then the result is indicative that the patient responds to the pharmacotherapy. As used herein, the term “expression” includes, but not limited to, (1) detecting transcription and/or translation of the biomarker gene, (2) detecting or determining the amount of mRNA or protein corresponding to the biomarker gene in the sample, or (3) both. To detect expression of a gene refers to the act of determining whether a gene is expressed or not. This can include determining whether the gene expression is upregulated, downregulated, or substantially unchanged as compared to a control. Therefore, the step of detecting expression does not require that expression of the gene actually is upregulated or downregulated, but rather, can also include detecting no expression of the gene or detecting that the expression of the gene has not changed or is not different (i.e., detecting no significant expression of the gene or no significant change in expression of the gene as compared to a control).

As disclosed herein, the present inventor has discovered a number of biomarker genes that are differentially expressed in a heart failure patient that responds to the pharmacotherapy and a heart failure patient that does not respond to the pharmacotherapy. As used herein, the term “responds to the pharmacotherapy” refers to an improvement in ejection of at least 5%. Patients who do not improve to this degree on beta-blockers are considered to be none responsive to the pharmacotherapy, and they have poor long term response. It has been found that about 20% of patients with idiopathic dilated cardiomyopathies (IDCM) do not respond to pharmacotherapy. The present inventor has identified a gene expression pattern that can accurately distinguish heart failure patients that respond to pharmacotherapy and those patients that do not.

Expression of the transcripts and/or proteins encoded by the genes of the invention is measured by any of a variety of known methods in the art. In general, the nucleic acid sequence of a nucleic acid molecule (e.g., DNA or RNA) in a patient sample can be detected by any suitable method or technique of measuring or detecting gene sequence or expression. Such methods include, but are not limited to, polymerase chain reaction (PCR), reverse transcriptase-PCR (RT-PCR), in situ PCR, quantitative PCR (q-PCR), in situ hybridization, Southern blot, Northern blot, sequence analysis, microarray analysis, detection of a reporter gene, or other DNA/RNA hybridization platforms, as well as mass spectrometry, etc. For RNA expression, methods can also include, but are not limited to, extraction of cellular mRNA and Northern blotting using labeled probes that hybridize to transcripts encoding all or part of one or more of the genes of this invention; amplification of mRNA expressed from one or more of the genes of this invention using gene-specific primers, polymerase chain reaction (PCR), quantitative PCR (q-PCR), and reverse transcriptase-polymerase chain reaction (RT-PCR), followed by quantitative detection of the product by any of a variety of means; extraction of total RNA from the cells, which is then labeled and used to probe cDNAs or oligonucleotides encoding all or part of the genes of this invention, arrayed on any of a variety of surfaces; in situ hybridization; and detection of a reporter gene. The term “quantifying” or “quantitating” when used in the context of quantifying transcription levels of a gene can refer to absolute or to relative quantification. Absolute quantification may be accomplished by inclusion of known concentration(s) of one or more target nucleic acids and referencing the hybridization intensity of unknowns with the known target nucleic acids (e.g., through generation of a standard curve). Alternatively, relative quantification can be accomplished by comparison of hybridization signals between two or more genes, or between two or more treatments to quantify the changes in hybridization intensity and, by implication, transcription level.

Methods to measure protein expression levels of selected genes of this invention, include, but are not limited to: Western blot, immunoblot, enzyme-linked immunosorbant assay (ELISA), radioimmunoassay (RIA), immunoprecipitation, surface plasmon resonance, chemiluminescence, fluorescent polarization, phosphorescence, immunohistochemical analysis, matrix-assisted laser desorption/ionization time-of-flight (MALDI-TOF) mass spectrometry as well as other mass spectrometry including that disclosed in the Examples section, microcytometry, microarray, microscopy, fluorescence activated cell sorting (FACS), flow cytometry, and assays based on a property of the protein including, but not limited to, DNA binding, ligand binding, or interaction with other protein partners.

Nucleic acid arrays are particularly useful for detecting the expression of the genes. The production and application of high-density arrays in gene expression monitoring have been disclosed previously in, for example, PCT Publication No. WO 97/10365; PCT Publication No. WO 92/10588; U.S. Pat. No. 6,040,138; U.S. Pat. No. 5,445,934; or PCT Publication No. WO 95/35505, all of which are incorporated herein by reference in their entirety. See also Hacia et al., Nature Genetics, 1996, 14, 441-447; Lockhart et al., Nature Biotechnol., 1996, 14, 1675-1680; and De Risi et al., Nature Genetics, 1996, 14, 457-460, all of which are incorporated by reference in their entirety. In general, in an array, an oligonucleotide, a cDNA, or genomic DNA, that is a portion of a known gene, occupies a known location on a substrate. A nucleic acid target sample is hybridized with an array of such oligonucleotides and then the amount of target nucleic acids hybridized to each probe in the array is quantified. One preferred quantifying method is to use confocal microscope and fluorescent labels. The Affymetrix GeneChip™ Array system (Affymetrix, Santa Clara, Calif.) and the Atlas™ Human cDNA Expression Array system are particularly suitable for quantifying the hybridization; however, it will be apparent to those of skill in the art that any similar systems or other effectively equivalent detection methods can also be used. In one embodiment, one can use the knowledge of the genes described herein to design novel arrays of polynucleotides, cDNAs or genomic DNAs for screening methods described herein. Such novel pluralities of polynucleotides are contemplated to be a part of the present invention.

Suitable nucleic acid samples for screening on an array contain transcripts of interest or nucleic acids derived from the transcripts of interest (i.e., transcripts derived from the biomarker genes of the invention). As used herein, a nucleic acid derived from a transcript refers to a nucleic acid for whose synthesis the mRNA transcript or a subsequence thereof has ultimately served as a template. Thus, a cDNA reverse transcribed from a transcript, an RNA transcribed from that cDNA, a DNA amplified from the cDNA, an RNA transcribed from the amplified DNA, etc., are all derived from the transcript and detection of such derived products is indicative of the presence and/or abundance of the original transcript in a sample. Thus, suitable samples include, but are not limited to, transcripts of the gene or genes, cDNA reverse transcribed from the transcript, cRNA transcribed from the cDNA, DNA amplified from the genes, RNA transcribed from amplified DNA, and the like. In some instances, such a sample is a total RNA preparation of a biological sample. In other embodiments, such a nucleic acid sample is the total mRNA isolated from a sample, e.g., endomyocardial biopsy sample of the patient.

In some embodiments, it is desirable to amplify the nucleic acid sample prior to hybridization. One of skill in the art will appreciate that whatever amplification method is used, if a quantitative result is desired, care must be taken to use a method that maintains or controls for the relative frequencies of the amplified nucleic acids to achieve quantitative amplification. Methods of “quantitative” amplification are well known to those of skill in the art. For example, quantitative PCR involves simultaneously co-amplifying a known quantity of a control sequence using the same primers. This provides an internal standard that may be used to calibrate the PCR reaction. The high-density array may then include probes specific to the internal standard for quantification of the amplified nucleic acid. Other suitable amplification methods include, but are not limited to, polymerase chain reaction (PCR) Innis, et al., PCR Protocols. A guide to Methods and Application, Academic Press, Inc. San Diego, (1990)), ligase chain reaction (LCR) (see Wu and Wallace, Genomics, 1989, 4, 560, Landegren, et al., Science, 1988, 241, 1077 and Barringer, et al., Gene, 1990, 89, 117, transcription amplification (Kwoh, et al., Proc. Natl. Acad. Sci. USA, 1989, 86, 1173), and self-sustained sequence replication (Guatelli, et al, Proc. Nat. Acad. Sci. USA, 1990, 87, 1874).

Nucleic acid hybridization involves contacting a probe and target nucleic acid under conditions where the probe and its complementary target can form stable hybrid duplexes through complementary base pairing. As used herein, hybridization conditions refer to standard hybridization conditions under which nucleic acid molecules are used to identify similar nucleic acid molecules. Such standard conditions are disclosed, for example, in Sambrook et al., Molecular Cloning: A Laboratory Manual, Cold Spring Harbor Labs Press, 1989, which is incorporated by reference herein in its entirety (see specifically, pages 9.31-9.62). In addition, formulae to calculate the appropriate hybridization and wash conditions to achieve hybridization permitting varying degrees of mismatch of nucleotides are disclosed, for example, in Meinkoth et al., Anal. Biochem., 1984, 138, 267-284, which is incorporated by reference herein in its entirety. Nucleic acids that do not form hybrid duplexes are washed away from the hybridized nucleic acids and the hybridized nucleic acids can then be detected, typically through detection of an attached detectable label. It is generally recognized that nucleic acids are denatured by increasing the temperature or decreasing the salt concentration of the buffer containing the nucleic acids. Under low stringency conditions (e.g., low temperature and/or high salt) hybrid duplexes (e.g., DNA:DNA, RNA:RNA, or RNA:DNA) will form even where the annealed sequences are not perfectly complementary. Thus specificity of hybridization is reduced at lower stringency. Conversely, at higher stringency (e.g., higher temperature or lower salt) successful hybridization requires fewer mismatches.

High stringency hybridization and washing conditions, as referred to herein, refer to conditions which permit isolation of nucleic acid molecules having at least about 80% nucleic acid sequence identity with the nucleic acid molecule being used to probe in the hybridization reaction (i.e., conditions permitting about 20% or less mismatch of nucleotides). Very high stringency hybridization and washing conditions, as referred to herein, refer to conditions which permit isolation of nucleic acid molecules having at least about 90% nucleic acid sequence identity with the nucleic acid molecule being used to probe in the hybridization reaction (i.e., conditions permitting about 10% or less mismatch of nucleotides). As discussed above, one of skill in the art can use the formulae in Meinkoth et al., ibid, to calculate the appropriate hybridization and wash conditions to achieve these particular levels of nucleotide mismatch. Such conditions will vary, depending on whether DNA:RNA or DNA:DNA hybrids are being formed. Calculated melting temperatures for DNA:DNA hybrids are 10° C. less than for DNA:RNA hybrids. In particular embodiments, stringent hybridization conditions for DNA:DNA hybrids include hybridization at an ionic strength of 6×SSC (0.9 M Na⁺) at a temperature of between about 20° C. and about 35° C. (lower stringency), typically between about 28° C. and about 40° C. (more stringent), and often between about 35° C. and about 45° C. (even more stringent), with appropriate wash conditions. In particular embodiments, stringent hybridization conditions for DNA:RNA hybrids include hybridization at an ionic strength of 6×SSC (0.9 M Na^{t}) at a temperature of between about 30° C. and about 45° C., typically between about 38° C. and about 50° C., and often between about 45° C. and about 55° C., with similarly stringent wash conditions. These values are based on calculations of a melting temperature for molecules larger than about 100 nucleotides, 0% formamide and a G +C content of about 40%. Alternatively, Tₘ can be calculated empirically as set forth in Sambrook et al., supra, pages 9.31 to 9.62. In general, the wash conditions should be as stringent as possible, and should be appropriate for the chosen hybridization conditions. For example, hybridization conditions can include a combination of salt and temperature conditions that are approximately 20-25° C. below the calculated Tₘ of a particular hybrid, and wash conditions typically include a combination of salt and temperature conditions that are approximately 12-20° C. below the calculated Tₘ of the particular hybrid. One example of hybridization conditions suitable for use with DNA:DNA hybrids includes a 2-24 hour hybridization in 6×SSC (50% formamide) at about 42° C., followed by washing steps that include one or more washes at room temperature in about 2×SSC, followed by additional washes at higher temperatures and lower ionic strength (e.g., at least one wash as about 37° C. in about 0.1×-0.5×SSC, followed by at least one wash at about 68° C. in about 0.1×-0.5×SSC). Other hybridization conditions, and for example, those most useful with nucleic acid arrays, will be known to those of skill in the art.

The hybridized nucleic acids are detected by detecting one or more labels attached to the sample nucleic acids. The labels may be incorporated by any of a number of means well known to those of skill in the art. Detectable labels suitable for use in the present invention include any composition detectable by spectroscopic, photochemical, biochemical, immunochemical, electrical, optical or chemical means. Useful labels in the present invention include biotin for staining with labeled streptavidin conjugate, magnetic beads (e.g., Dynabeads™), fluorescent dyes (e.g., fluorescein, texas red, rhodamine, green fluorescent protein, yellow fluorescent protein and the like), radiolabels (e.g., 3H, ¹²⁵I, ³⁵S, ¹⁴C, or ³²P), enzymes (e.g., horse radish peroxidase, alkaline phosphatase and others commonly used in an ELISA), and colorimetric labels such as colloidal gold or colored glass or plastic (e.g., polystyrene, polypropylene, latex, etc.) beads. Means of detecting such labels are well known to those of skill in the art. Thus, for example, radiolabels may be detected using photographic film or scintillation counters, fluorescent markers may be detected using a photodetector to detect emitted light. Enzymatic labels are typically detected by providing the enzyme with a substrate and detecting the reaction product produced by the action of the enzyme on the substrate, and colorimetric labels are detected by simply visualizing the colored label.

The method of the present invention can includes a step of comparing the results of detecting the expression of the biomarker genes that are differentially expressed in heart failure patients who respond to pharmacotherapy compared to heart failure patients do not respond to pharmacotherapy in order to determine whether the expression level of biomarker genes is statistically more similar to the expression level of the biomarker genes that has been associated with the heart failure patient that responds to the pharmacotherapy or to the expression level of the biomarker genes that has been associated with the heart failure patient that does not respond to the pharmacotherapy.

According to the present invention, an expression level is substantially similar to a given expression level established for a group if the expression level of the gene is similar enough to the expected result so as to be statistically significant (i.e., with at least a 95% confidence level, or p<0.05, typically with a confidence level of p<0.01, often with a confidence level of p<0.005, and more often with a confidence level of p<0.001). Software programs are available in the art that are capable of analyzing the expression of multiple genes and determining whether differences from a control are significant or not significant.

The expression level of genes can be used by the patient or physician for decision-making regarding the usefulness of pharmacotherapy or a need for other type of treatment such as implantable defibrillators, artificial hearts, or cardiac transplantation.

MicroRNAs (miR's) are small, typically about 22 nucleotides, non-coding RNAs that inhibit translation and/or accelerate mRNA turnover in mammalian systems. The mechanism(s) by which miRNAs affect gene expression, beyond the categorical descriptions of affecting protein translation (repression) and mRNA turnover (acceleration), are only now beginning to emerge. By virtue of these functions, miR's have been demonstrated to be important regulators of many genes in a variety of disease states as well as being major regulators of developmental and growth-related processes. Recently, a number of studies have demonstrated the importance of miR's in the regulation of cardiac disease. The present inventor has discovered that several miR's including miR-1, 21, 29, 133a,b 150, 195, and 208, play a significant role in the process of cardiac remodeling, putatively by regulating changes in gene expression that accompany pathological cardiac hypertrophy and contractile dysfunction. In addition to affecting directly cardiac myocyte phenotype, the emerging role of miR's in the regulation of cardiac fibroblasts, angiogenesis, and kinase signaling cascades has been observed.

The present inventor has discovered that miRNAs are not only differentially expressed in failing versus non-failing human hearts, but that there are also differences in miR expression based on the type of heart failure, i.e., idiopathic dilated versus ischemic cardiomyopathy. The present inventor has discovered that a combination of miR/mRNA array analysis is, in some instances, a superior prognostic marker of response to beta-blocker therapy. In some embodiments, methods of the invention include integrating complementary protein analyses.

Without being bound by any theory, it is believed that cardiac muscle dysfunction results from activation of signaling pathways in the myocyte that lead to increased myocyte loss and altered patterns of protein expression (transcriptional regulation) and phosphorylation (post-translational regulation), resulting in depressed force generation and calcium sensitivity of the contractile elements. In addition to the changes in protein isoform expression [the classic example being a shift from the a to the β isoform of myosin heavy chain (MHC)], the present inventor has identified stage- and disease-specific protein modifications that are believed to define a “protein and phosphoprotein fingerprint” of cardiac (mal)adaptation.

An analysis of the impact of phosphorylation of the thin filament protein, troponin (Tn) I, confirmed this finding. Phosphorylation of the cardiac isoform of TnI at Serine 22,23 in the unique N-terminal end of the molecule has previously been shown to decrease the calcium sensitivity of the sarcomere, promote calcium dissociation from troponin C, and by extension, enhance rates of cross-bridge cycling and diastolic relaxation. There are at least three other potential kinase dependent sites in the molecule (largely presumed to be PKC specific), at Ser 43,45, a region that interacts with the C-lobe of TnC and the C-terminal region of TnT, and Thr 144 in the IP loop of the molecule. PKC phosphorylation of TnI (largely at Ser 43, 45) inhibits the actin-cross bridge reaction and reduces the Ca⁺² dependent actomyosin ATPase rate as well as the calcium sensitivity of force generation. Phosphorylation at Thr 144 (mediated by several PKC isoforms) reduces maximal tension development and cross-bridge cycling rates. The impact of sarcomeric phosphorylation on sarcomere dynamics is not limited to this single protein and there is ample evidence that targeted phosphorylation of other sarcomeric proteins, including TnT, myBP-C and MLC2 all have definable impacts on sarcomere dynamics and that phosphorylation events are cooperative. For example, phosphorylation of MLC2 increases myofilament calcium sensitivity (and transgenic replacement with a non-phosphorylatable MLC2 isoform eliminates the MLCK effect on the tension:Ca relationship) with only a modest effect on tension development. These data suggest the importance of a model that uses several protein and phosphoprotein alterations that manifest in DCM to predict clinical response.

It is believed that at least some human heart failure is associated with a low level of thin filament protein phosphorylation and an increase in calcium sensitivity of contraction relative both to “control” human heart tissue and also to murine heart. However, this view is clouded by inconsistent definitions of what constitutes “control” human heart tissue as well as by different strategies for tissue procurement, some of which include exhaustive cardioplegia and collagenase treatment, which is believed to dephosphorylate at least some contractile proteins. An additional concern is that almost all studies have relied on tissue from end-stage human heart disease, which may not be the ideal context within which to evaluate potential therapeutic manipulations. In contrast, the present inventor has developed procedures for obtaining tissue in a manner designed to preserve in situ phosphorylation status and allow correlation with functional recovery.

The concept of monitoring specific peptides from proteins of interest is well-established, and numerous derivations of targeted mass spectrometry using specific acquisition of peptide tandem mass spectra predicted in silico have been reported. Recently, these methods have been based on the use of selected reaction monitoring (SRM) assays on triple quadrupole mass spectrometers. SRM assays have high specificity within complex mixtures and can be performed in a fraction of the instrument time relative to discovery-based approaches. In general, targeted studies are intended to complement discovery-based analyses and facilitate hypothesis-driven proteomic experiments.

Targeted Selected Reaction Monitoring (SRM) Mass Spectrometry Assays can be used for high-throughput quantification of selected proteins. In a complex mixture, the chemical background of co-eluting analytes can mask the detection of a precursor ion in a data-dependent analysis. However, if the precursor ion m/z is known, a triple quadrupole mass spectrometer can be used to minimize the chemical interference using two separate stages of mass analysis to selectively monitor a unique peptide using SRM assays (“MS Westerns”). With SRM, only predetermined precursor and product ion pairs are monitored in an MS/MS experiment. The combined specificity of chromatographic retention time, precursor ion mass, and product ion mass allow the selective identification of a unique peptide and its respective protein within a complex mixture. By combining SRM and labeled internal standards, absolute peptide amounts can be determined. Stable isotope labeled proteins/peptides were synthesized, mixed with the complex sample, and analyzed by μLC/MS/MS. The native peptide and its labeled standard co-elute into the mass spectrometer, and both m/z ranges (the native peptide and the labeled standard peptide) were selected for fragmentation. One of the resulting product ion pairs was then monitored and the ratio of their total ion currents (TIC) corresponded to the ratio of the peptides. Targeted SRM assays can be multiplexed to quantify multiple transitions for multiple peptides in any given experiment and can be automated for high-throughput analyses. Multiplexed SRM assays were developed by the present inventor to rapidly assess the predictive utility of each of the BORG candidate protein biomarkers (including phosphorylated protein isoforms).

Some methods of the invention allow personalized targeted approach to patient care, incorporating molecular biomarkers from endomyocardial biopsies into a predictive model. Methods of the invention allow early identification of non-responders. Such knowledge can be used to target intervention against preventing sudden cardiac death or death due to pump failure. Conversely, patients who are classified as responders by methods of the invention could be managed conservatively with optimal medical therapy. Methods of the invention can be used to restrict complex and costly interventions to patients who can benefit and allow these patients to receive earlier, preventive care.

Additional objects, advantages, and novel features of this invention will become apparent to those skilled in the art upon examination of the following examples thereof, which are not intended to be limiting. In the Examples, procedures that are constructively reduced to practice are described in the present tense, and procedures that have been carried out in the laboratory are set forth in the past tense.

### EXAMPLES

Patients with idiopathic dilated cardiomyopathy, LVEF<40%, NYHA class Endomyocardial biopsies were conducted at baseline and 3 months for measurement of global gene expression utilizing the Affymetrix U133 plus 2 array. Data was analyzed i GeneSifter utilizing a p<0.001.

### Results

The mean patient age was 45.8±12.4 years, and mean LVEF was 25.7±8%. Twenty-four of the subjects were men and 4 were women. Differentially expressed genes in response to beta-blocker therapy were identified as shown Table below, which also lists Affymatrix probe sets used to identify the gene, RefSeqID, and p-values. These genes include (1) vitronectin (p=0.00087, 1.57 fold decrease) a secreted protein which promotes cell adhesion and spreading; (2) protein kinase C beta II (p=0.0001, 1.56 fold increase), a calcium activated protein which phosphorylates a wide variety of targets; (3) pericentrin (p=0.00074, 1.31 fold increase), which is important to normal function of the centrosome, the cytoskeleton and cell cycle progression; and (4) protein tyrosine phophatase, receptor C (p=0.0008, 1.59 fold increase) which suppresses JAK kinases and functions a regulator of cytokine signaling.

Table of Differentially Expressed Genes in Response to β-Blocker

| AffYProbeID | Gene | RefSeqID | p-value |
|---|---|---|---|
| 229309_at | ADRB1 | NM_000864 | 0.0124 |
| 218568_at | AGK | NM_018238 | 0.00096 |
| 224682_at | ANKIB1 | NM_019004 | 0.00175 |
| 205507_at | ARHGEF15 | NM_173728 | 6E−05 |
| 222550_at | ARMC1 | NM_018120 | 0.0004 |
| 226251_at | ASXL2 | NM_018263 | 0.0007 |
| 201972_at | ATP6V1A | NM_001690 | 0.0006 |
| 201089_at | ATP6V1B2 | NM_001693 | 0.00041 |
| 213744_at | ATRNL1 | NM_207303 | 0.0294 |
| 219487_at | BBS10 | NM_024685 | 0.00107 |
| 1560977_a_at | BCL2L13 | NM_015367 | 0.0001 |
| 202710_at | BET1 | NM_005868 | 0.0004 |
| 201170_s_at | BHLHE40 | NM_003670 | 0.00177 |
| 219240_s_at | C10orf88 | NM_024942 | 6.2E−05 |
| 1555390_at | C14orf21 | NM_173913 | 0.0002 |
| 226608_at | C16orf87 | NM_001001436 | 0.00067 |
| 244103_at | C1orf55 | NM_152608 | 0.00113 |
| 231921_at | C2orf37 | NM_025000 | 0.0005 |
| 203738_at | C5orf22 | NM_018356 | 0.00042 |
| 223740_at | C6orf59 | NR_024277 | 0.0009 |
| 204865_at | CA3 | NM_005181 | 0.0026 |
| 201237_at | CAPZA2 | NM_006136 | 0.0002 |
| 219342_at | CASD1 | NM_022900 | 0.0009 |
| 219645_at | CASQ1 | NM_001231 | 0.0547 |
| 204995_at | CDK5R1 | NM_003885 | 3E−06 |
| 219294_at | CENPQ | NM_018132 | 0.00095 |
| 206210_s_at | CETP | NM_000078 | 0.0095 |
| 219397_at | COQ10B | NM_025147 | 0.0002 |
| 201119_s_at | COX8A | NM_004074 | 5E−05 |
| 223271_s_at | CTDSPL2 | NM_016396 | 0.00179 |
| 203669_s_at | DGAT1 | NM_012079 | 1E−04 |
| 220926_s_at | EDEM3 | NM_025191 | 0.00183 |
| 219232_s_at | EGLN3 | NM_022073 | 0.00204 |
| 225855_at | EPB41L5 | NM_020909 | 0.00107 |
| 235215_at | ERCC4 | NM_005236 | 4.85E−05 |
| 230368_at | ERF | NM_006494 | 0.0201 |
| 219498_s_at | ERO1L | NM_014584 | 0.00037 |
| 226431_at | FAM117B | NM_173511 | 0.00137 |
| 232217_at | FAM26E | NM_153711 | 0.0008 |
| 205140_at | FPGT | NM_003838 | 0.00094 |
| 230418_s_at | GALNTL1 | NM_020692 | 9E−05 |
| 236548_at | GIPC2 | NM_017655 | 0.00207 |
| 223079_s_at | GLS | NM_014905 | 0.0047 |
| 59999_at | HIF1AN | NM_017902 | 0.00022 |
| 222305_at | HK2 | NM_000189 | 0.0091 |
| 206601_s_at | HOXD3 | NM_006898 | 0.0009 |
| 202854_at | HPRT1 | NM_000194 | 0.00111 |
| 230556_at | IMMP1L | NM_144981 | 0.0009 |
| 203275_at | IRF2 | NM_002199 | 0.0007 |
| 209274_s_at | ISCA1 | NM_030940 | 0.00018 |
| 206765_at | KCNJ2 | NM_000891 | 0.00064 |
| 202419_at | KDSR | NM_002035 | 0.00032 |
| 204075_s_at | KIAA0562 | NM_014704 | 0.00112 |
| 213358_at | KIAA0802 | NM_015210 | 0.00127 |
| 218604_at | LEMD3 | NM_014319 | 0.00043 |
| 232281_at | LOC148189 | NR_027301 | 0.0384 |
| 218577_at | LRRC40 | NM_017768 | 0.00203 |
| 231640_at | LYRM5 | NM_001001660 | 0.0007 |
| 229286_at | MAGEE1 | NM_020932 | 0.00172 |
| 209397_at | ME2 | NM_002396 | 0.0006 |
| 218247_s_at | MEX3C | NM_016626 | 0.0009 |
| 224873_s_at | MRPS25 | NM_022497 | 0.0214 |
| 210319_x_at | MSX2 | NM_002449 | 0.00033 |
| 222422_s_at | NDIFP1 | NM_030571 | 0.0009 |
| 222774_s_at | NETO2 | NM_018092 | 0.0357 |
| 229491_at | NHEDC2 | NM_178833 | 0.00151 |
| 224938_at | NUFIP2 | NM_020772 | 0.00279 |
| 231838_at | PABPC1L | NM_001124756 | 0.0002 |
| 231789_at | PCDHB15 | NM_018935 | 0.00114 |
| 208638_at | PDIA6 | NM_005742 | 0.00016 |
| 212726_at | PHF2 | NM_005392 | 2E−05 |
| 223370_at | PLEKHA3 | NM_019091 | 0.00024 |
| 228202_at | PLN | NM_002667 | 0.0323 |
| 204517_at | PPIC | NM_000943 | 0.00016 |
| 204566_at | PPM1D | NM_003620 | 0.00026 |
| 218040_at | PRPF38B | NM_018061 | 0.00073 |
| 213923_at | RAP2B | NM_002886 | 0.0012 |
| 51228_at | RBM12B | NM_203390 | 0.0006 |
| 229431_at | RFXAP | NM_000538 | 0.00056 |
| 226028_at | ROBO4 | NM_019055 | 6E−05 |
| 224844_at | SLAIN2 | NM_020846 | 0.00044 |
| 241866_at | SLC16A7 | NM_004731 | 0.00049 |
| 223441_at | SLC17A5 | NM_012434 | 0.00087 |
| 202527_s_at | SMAD4 | NM_005359 | 0.0004 |
| 200071_at | SMNDC1 | NM_005871 | 9.12E−05 |
| 221561_at | SOAT1 | NM_003101 | 0.0048 |
| 229075_at | SPATA5 | NM_145207 | 0.001 |
| 218817_at | SPCS3 | NM_021928 | 1.85E−05 |
| 210715_s_at | SPINT2 | NM_021102 | 6E−05 |
| 223013_at | TBL1XR1 | NM_024665 | 4.00E−05 |
| 213417_at | TBX2 | NM_005994 | 1E−05 |
| 211703_s_at | TM2D1 | NM_032027 | 4E−05 |
| 227753_at | TMEM139 | NM_153345 | 3.95E−05 |
| 226860_at | TMEM19 | NM_018279 | 0.00076 |
| 238045_at | TMEM65 | NM_194291 | 0.00442 |
| 211763_s_at | UBE2B | NM_003337 | 2E−06 |
| 203343_at | UGDH | NM_003359 | 0.00161 |
| 41856_at | UNC5B | NM_170744 | 9E−05 |
| 204534_at | VTN | NM_000638 | 1E−05 |
| 219297_at | WDR44 | NM_019045 | 0.0007 |
| 226501_at | XPNPEP3 | NM_022098 | 0.00113 |
| 220243_at | ZBTB44 | NM_014155 | 0.0009 |
| 231899_at | ZC3H12C | NM_033390 | 0.0005 |
| 219062_s_at | ZCCHC2 | NM_017742 | 0.0009 |
| 228749_at | ZDBF2 | NM_020923 | 0.00124 |
| 239043_at | ZNF404 | NM_001033719 | 5E−05 |
| 1558941_at | ZNF704 | NM_001033723 | 7.67E−05 |
| 227122_at | ZNF791 | NM_153358 | 2E−05 |

Phenotypic changes in myocardial function on beta-blocker therapy are associated with complex molecular remodeling. These changes in gene expression involve pathways which regulate myocyte remodeling, metabolism, and intracellular signal transduction.

### β-Blocker on Remodeling and Gene Expression (BORG) Trial

The BORG study was used to compare myocardial gene expression with alterations in ventricular myocardial phenotype in patients with idiopathic dilated cardiomyopathy treated for 18 months with either metoprolol (β₁-receptor blockade), metoprolol plus doxazosin (β₁ plus α₁-receptor blockade) or carvedilol (β₁ plus α₁ plus β₂-receptor blockade). Phenotypic, transcriptomic, and proteomic data were prospectively collected on these patients. Patients underwent endomyocardial biopsy as part of their cardiomyopathy evaluation. Four to five biopsies were taken and placed immediately in liquid nitrogen for gene expression analysis. Obstructive coronary artery disease was excluded by coronary angiography and myocardial inflammation and infiltrative processes were excluded by histopathology. During the course of this study, the present inventor has developed methodology to obtain and analyze simultaneously mRNA, miRNA, proteins and phosphorylated isoforms in these endomyocardial biopsies.

### Study Population

A total of 72 patients with idiopathic dilated cardiomyopathy were randomized in the BORG study. Data was derived from an initial subset of 27 patients who were stratified into two groups based on LVEF response to therapy (Responders≧5 EF unit increase in EF over 12 months). The characteristics of these patients are shown in Table 1.

TABLE 1
Patient Characteristics

| | Responders | Non-Reponders |
|---|---|---|
| N | 18 | 9 |
| Gender (% male) | 66 | 66 |
| Age | 40 ± 13 | 47 ± 13 |
| Treatment Arm (M/MD/C) | 6/7/5 | 2/2/5 |
| Race (% Caucasian) | 61 | 66 |
| Change LVEF | 24 ± 10 | 1.6 ± 4* |

(* = p < 0.05 vs responders, data represented ± SD, M = metoprolol, MD = metoprolol + doxazosin, C = carvedilol)

mRNA Results

Myocardial gene expression was measured using the Affymetrix U133 Plus 2 array. Responders and non-responders were compared using GeneSifter®, a commercially available software tool. As gene expression data is often non-parametric, differences in gene expression were evaluated using Wilcoxon signed-rank test. Data was normalized to the mean chip value. To limit false discovery rates, a Benjamini and Hochberg correction was used with an adjusted p-value<0.05 and a>1.5 fold change as significant. Global gene expression analysis identifies 196 genes differentially expressed in non-responders compared to controls. Ontological analysis revealed differential expression of genes involved in metabolism, the cell cycle, nervous system development and organ system processes. Included in this list of 196 genes are several sarcomeric proteins. See Table 2. Beta myosin heavy chain (β-MHC) expression was increased 1.59 fold in responders compared to non-responders (p=0.028). Similarly, skeletal embryonic myosin light chain 1 (MLC1) expression was increased 1.6 fold (p=0.019), and fast skeletal troponin (TNNT3) was increased 2.1 (p=0.024). These are believed to be fetal isoforms not normally expressed at these levels in adults. Induction of these fetal isoforms can be used to determine response to beta-blocker therapy. β-MHC mRNA expression levels by themselves have a sensitivity of 89% and specificity of 72% for identifying responders.

TABLE 2
mRNA Expression of Sarcomeric Proteins

| | Responders | Non-Responders |
|---|---|---|
| β-MHC | 186 ± 27 | 117 ± 12* |
| TNNT-3 | 15.9 ± 1.4 | 7.5 ± 1.6* |
| MLC1 | 135 ± 11.6 | 83.5 ± 15.5* |

(data expressed as signal intensity, * = p < 0.05 vs responders).

MHC isoform shifts influence cardiac function. β-MHC which is the predominant mRNA and protein isoform in the non-failing adult human heart is further up-regulated in heart failure independent of the etiology whereas a-MHC is down-regulated resulting in reduced myofibrillar ATPase activity and slower rates of contraction. Without begin bound by any theory, it is believed that beta-blockers improve cardiac function in heart failure in part by reversing these sarcomeric isoform shifts. These isomeric shifts of MHC, along with numerous other changes in gene expression, mimic patterns seen during development and are commonly referred to as a “fetal gene program” (FGP).

A promoter analysis of differentially expressed genes which allows for the identification of transcription factor binding sites which facilitate the transcription of particular genes was conducted to search for new motifs within pathway specific co-expressed genes that may represent transcription factor binding sites (TFBSs) as well as to identify previously established over-represented predicted TFBSs within these genes. With the use of MEME 4.0, and oPOSSUM Human Combination Site Analysis (CSA) and Human Single Site Analysis (SSA) several regions of DNA were identified that appear to represent a transcriptional control of differentially expressed genes. These included MEF2A, SP1, and several forkhead transcription factors.

MEF2 is a transcription factor that regulates numerous development processes and responses to stress and also appears to play a central role in the induction of the FGP. MEF-2 activity is modulated by both MAP kinase and Ca⁺² signaling. The promoter analysis showed that activation of adrenergic pathways is necessary for beta-blocker therapy to be effective. As described in detail below, miRNAs are non-coding RNAs that pair with specific mRNA targets to inhibit translation or enhance degradation thereby regulated gene expression. The mRNA data obtained from BORG indicated that reversal to a fetal pattern of gene expression was associated with response to beta blocker therapy.

miRNA Data

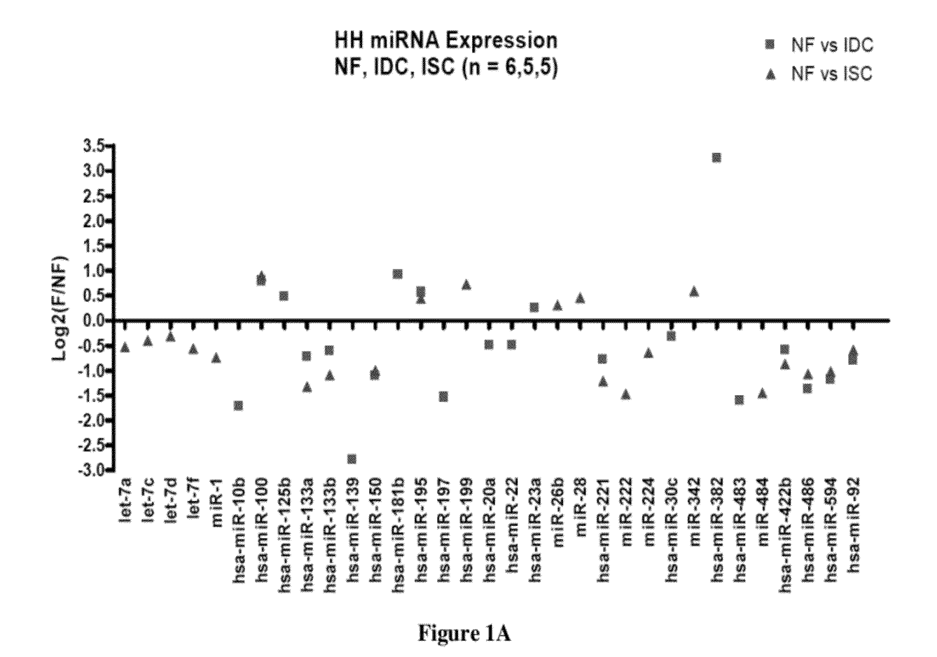

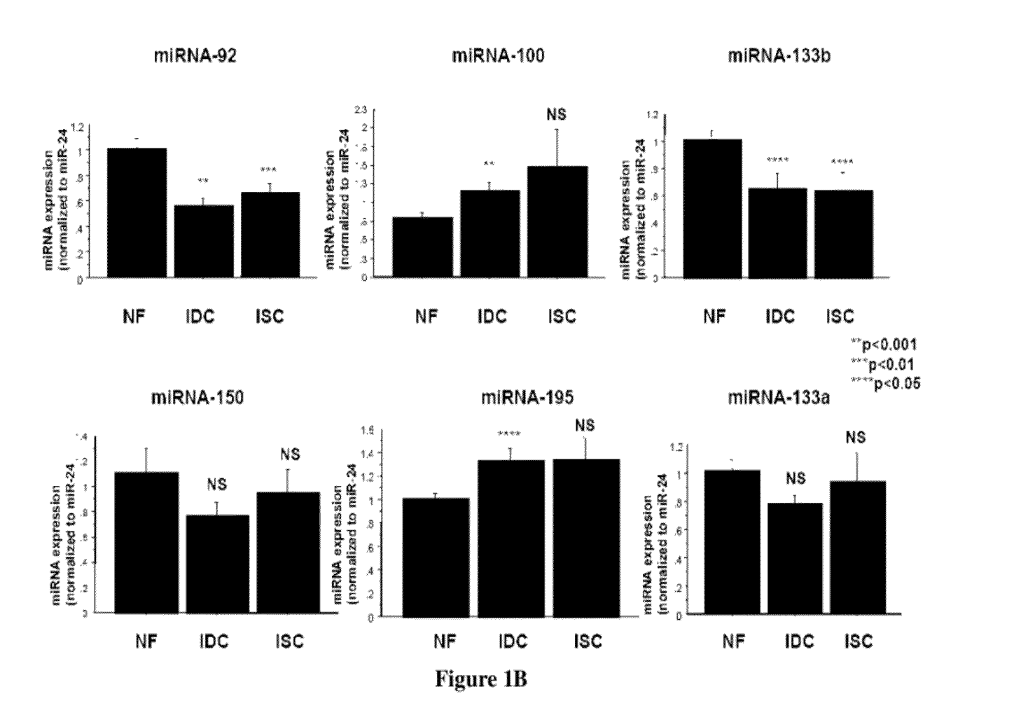

The differential expression of miRNAs and mRNAs in non-failing and failing human hearts was examined. miRNA array analysis was performed on 6 non-failing (NF), and 10 failing (F) (5 IDC, 5 ISCH). As shown in FIGS. 1A and 1B, a number of individual miRNAs were found to be up- or down-regulated secondary to heart failure. In some cases, there was consistency between “failure” phenotypes; however, this was not uniform. These data demonstrate that miRNA expression patterns can be segregated by phenotype. In addition, changes in pattern of miR expression can be correlated with the degree of heart failure.

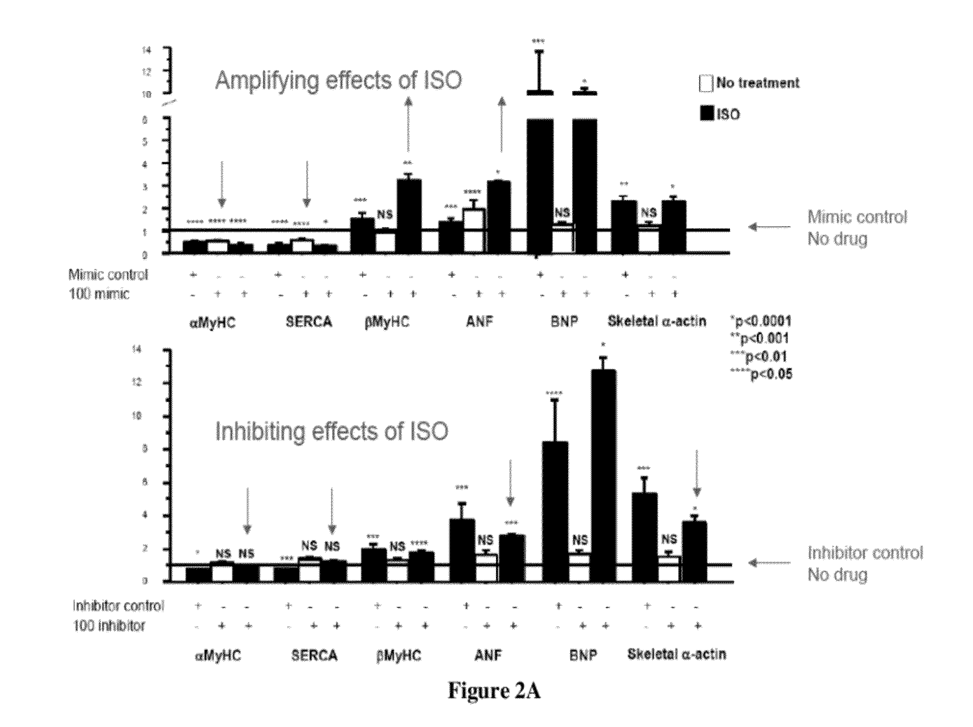

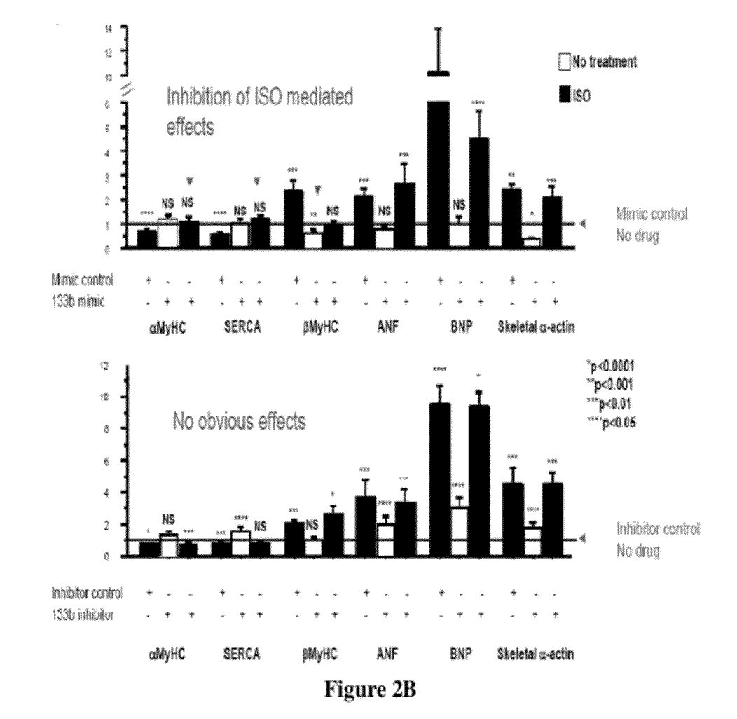

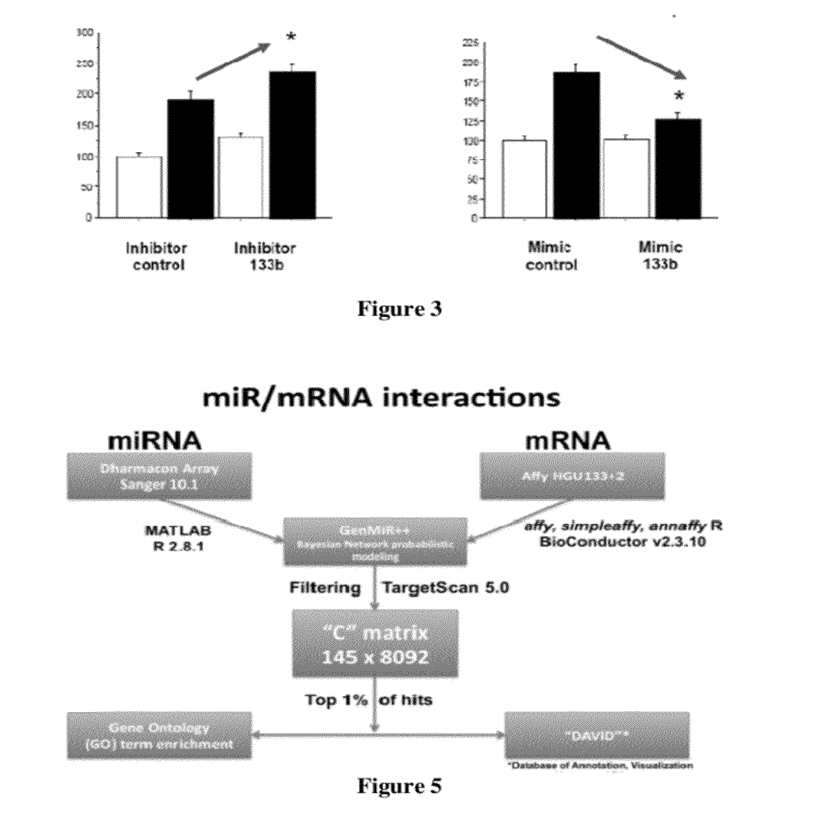

To examine the potential relevance of several of these miRNAs to the heart failure phenotype, individual mimics or inhibitors for miR's 100, 92, and 133b were transfected into primary cultures of neonatal rat ventricular myocytes (NRVMs). The phenotypic effects of miR's mimics and inhibitor on NRVMs were assessed in two ways. First, the effects of miR expression on the fetal gene program (FGP, defined as the relative mRNA expression of α- and α-MHC, SERCA2a, ANF, BNP and a-skeletal actin) were examined. Second, the effects of miR over-expression and inhibition on NRVM morphology (size) were examined. As shown in FIGS. 2A and 2B, over-expression (i.e., o/e) of a miR-100 mimic accentuated the effects of isoproterenol (ISO) treatment on FGP expression. Conversely, o/e of a miR-100 attenuated ISO's effects. In contrast, o/e of a miR-133 mimic inhibited ISO-mediated effects on the FGP, a finding confirmed in FIG. 3, where a miR-133 mimic inhibited ISO induced cellular hypertrophy whereas a miR-133 inhibitor accentuated the pro-hypertrophic effects of ISO.

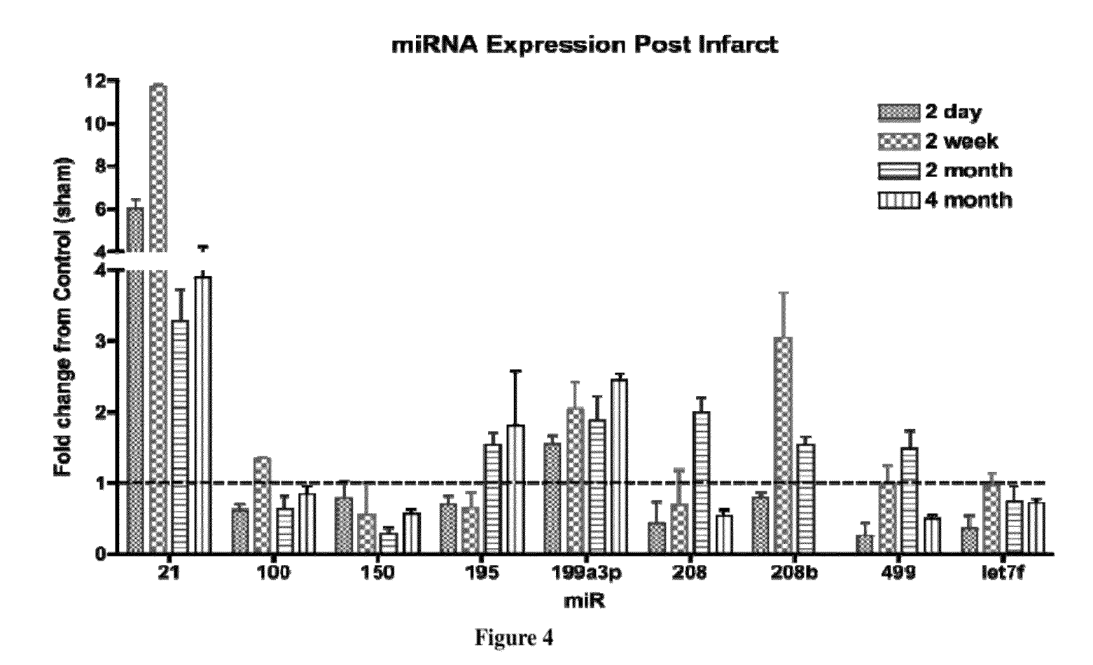

Changes in miR expression secondary to myocardial infarction (MI) were also examined. MI is often followed by progressive left ventricular remodeling and dysfunction. Mice underwent LAD ligation or sham operation. Post infarction, cardiac function was assessed by echocardiography which in each case was markedly reduced from about 60% in control animals to about 20% in infarcted animals. Animals were studied at multiple time points post infarction including: two days (acute), two weeks, and two and four months (chronic). FIG. 4 show that a number of miRNAs (e.g., 21, 100, 150, 195, 199a-3p, 208, 208b, 499 and let-7f) were differentially regulated post MI. Several miR's displayed acute behavior (at 2 days) directionally opposite that of later time points (2 weeks, 2 and 4 months).

Cross-Correlation of miRNA/mRNA Expression

Novel predictive miRNA/mRNA interactions in heart failure were identified, for example, by examining the cross-correlation between miRNAs and mRNAs in human heart endomyocardial biopsy samples obtained in conjunction with the BORG Trial. Bioinformatic analysis of existing human miRNA and mRNA array data were also analyzed to identify predictive miR/RNA target pairs. Described below demonstrates methods for analyzing complex data sets in cell culture model systems, i.e., NRVM's. Relative co-expression of miR's and mRNAs in 10 heart failure patients were analyzed across three time points: baseline, and at 3 and 12 months post initiation of beta blocker therapy. These patients were stratified into responders and non-responders based on improvements in cardiac ejection fraction. Expression profiling of miRNAs (MiRBase v10.1) was determined using the Dharmacon array platform with an external reference library. Summarized below are the number of interactions in the data set and the number of very high probability miR/mRNA interactions (as defined by reciprocal expression of miR and target gene). The sequence based target prediction matrix “C” was created by downloading the “Conserved_Family_Conserved_Targets_Info” and “miR_Family_Info” files from TargetScanS (v5.0) and modified to include only those miRNAs and mRNAs expressed in the heart biopsies presented here. Likewise, miRNAs and mRNAs in the expression set but absent from the C matrix were removed. Overall, the dataset was reduced to 60,094 possible target-pair interactions that were scored by GenMiR++ [C matrix of 8,170 genes, 143 miRs (GenMiR++ is a Bayesian Network program of probabilistic modeling). The highest confidence data set (i.e., top 1%) contains 601 interacting pairs comprising 345 genes and 70 unique miRNAs. Target pairs underwent further analysis including “GO term” enrichment analysis (frequency of both ‘biological process’ and ‘molecular function’ ontology terms) to identify overrepresentation of biological concepts. The identification of Gene Ontology (GO) term enrichment was achieved using the GOstat web application with the human background database (goa_human). In this analysis, there were a number of instances where the same miR paired with multiple mRNA targets. Similarly, there were a number of instances where the same mRNA was paired with more than one miR. It is believed that in miRNA biology, there are redundancies within targets and pathways.

Examples of miR's targeting multiple RNAs (>10) include, but are not limited to, let-7's, miR-1 (regulator of MEF2a and the hypertrophic gene program), 101, 103, 106a,b, 125a-5p, 125b, 129-5p, 133a,b (putative regulator of the mRNA binding protein, HuR, which stabilizes β-AR mRNA, and a regulator of the FGP and cardiac hypertrophy), 143, 15a,b, 181a,b, 185, 186 (highly enriched for potential targets), 19b, 203, 23a,b, 25, 26a,b, 27a, and 30a,b, (putatively involved in β-AR signaling).

Examples of genes with multiple miR binding sites include, but are not limited to, CHEK1, multiple FAM's, HOXA9 (targeted by miR's 125a-5p, let-7s, 133a,b; noted above), several KCN's (K+ channels), and RIMBP2/RIMS2.

In heart failure, changes in the relative expression of a circumscribed set of miR's were consistent. In addition, it was found that simultaneous analysis of miR and mRNA expression showed distinctly additive value. Given the known mechanisms of gene regulation by miR's, simultaneous examination of miR/mRNA/protein expression in the BORG data set represents a highly novel, useful pathway to define high-value prognostic markers of response to beta blocker therapy.

### Proteomic Data

A high-throughput proteomic pipeline was used to develop multiplexed targeted mass spectrometry (MS) assays (i.e., multiplexed SRM assays or “MS Westerns”). Briefly, SRM assays were first optimized for selected unique peptides from target proteins. The primary amino acid sequence of each target protein was analyzed in silico to find unique tryptic peptides. An extensive human heart proteome database was established which is composed of >5,000 protein entries. This database was first queried for representative tandem mass spectra (MS/MS spectra) from the selected unique sequences. If spectra were found in the database, key information necessary for the development of the SRM assay is already available (i.e. ionization efficiency of peptide, chromatographic retention time, and fragment ion intensities). Relative fragment y-ion intensities in tandem mass spectra generated on ion trap mass spectrometers correlate with those generated using triple quadrupole mass spectrometers. These data can be used to predict the precursor-to-product ion transition to be monitored in the SRM assay. If the spectrum was not found in the database, synthetic peptides were acquired and used for the characterization of ionization efficiency, chromatographic retention time and optimal precursor-to-product transitions. Once characterized, SRM assays were optimized for each selected unique peptide (native peptide and native plus synthetic peptide) in the context of the biological matrix in which the assay are performed. This step is useful because matrix ion suppression effects are frequently observed and vary with each different biological matrix.

Development of SRM assays for the quantitative detection of peptides in the context of human heart tissue is demonstrated below. Briefly, an SRM assay was performed for detection of a-MHC6 peptide (IEELEEELEAER) in a tryptic digest of an unfractionated human heart explant. Because the explanted tissue also included blood, the biological complexity of this unfractionated heart sample was most likely equal to or greater than plasma. The total ion current (TIC) was monitored for each precursor-to-product transition for the entire product y-ion series.

To demonstrate the power of the SRM approach for the analysis of protein isoforms, myosin heavy chain isoforms a-MHC6 and β-MHC7 were both monitored in an SRM assay. These protein isoforms are difficult to distinguish using traditional immunoassay methods. They are 93% identical, virtually indistinguishable by molecular weight, and antibodies made to either protein cross reacts with the other. However, using SRM assays to target the detection of unique peptides, these two proteins were easily distinguished and quantified using only 2 transitions each. This feature of SRM assay is useful in distinguishing between protein isoforms, particularly those resulting from single nucleotide polymorphisms (SNPs) and/or post-translational modifications (e.g., phosphorylation).

The ability to detect low abundance proteins in the context of a complex unfractionated tissue sample is demonstrated below. The detection and relative quantification of the β-adrenergic receptor (previously reported to be present at low femtomole levels per mg human heart tissue) was performed. Both β-adrenergic receptor and calsequestrin (control protein reported to remain unchanged in heart failure) were monitored in unfractionated human heart samples taken from explanted tissue from 20 individuals diagnosed with heart failure and 20 individuals with non-failing hearts. The β-adrenergic receptor was shown to have about 2-fold increase in failing samples compared to non-failing samples, whereas there was no significant change in calsequestrin.

SRM assays can easily be multiplexed for the measurement of many peptides in one assay, for example, by taking advantage of prior knowledge of peptide retention time. This facilitates many more transitions to be included in one assay by only monitoring for peptides during the chromatographic time corresponding to when the peptide is eluted. Ability to develop a multiplexed SRM assay in the context of a complex unfractionated tissue sample was demonstrated as follows. A time scheduled SRM assay was performed for the detection of 16 unique peptides from 12 cardiac proteins in a tryptic digest of an unfractionated human heart explant sample. The sum TIC of 2 selected precursor-to-product transitions for each of the 16 peptides were monitored over a 65 minute reversed-phase (RP) gradient. Because each peptide has a unique retention time, instead of monitoring all 32 transitions throughout the entire analysis, selected peptides were scheduled for analysis only during specified chromatographic time segments. This decreased the number of peptide transitions monitored per time segment and increased the precision of the measurements. These results demonstrated that multiplexed SRM assays can be multiplexed for unfractionated tissue/blood protein samples.

Candidate biomarker proteins that were found to be differentially expressed from the mRNA data acquired from the BORG endomyocardial biopsy samples were quantified. These proteomic analyses were conducted concurrently from protein samples extracted from the same original RNA extracted biopsy.

Isotope-labeled internal standards for 7 unique peptides were included in a multiplexed SRM analysis and absolute native peptide amounts were determined in BORG biopsies during the course of beta-blocker treatment. These data included 1 responder (R) and 1 non-responder (NR). However, these results demonstrated that 1) absolute peptide measurements can be assessed down to the low femtomolar range and 2) the limit of quantitation (LOQ) is in the low femtomolar range and the limit of detection is in the mid-attomolar range (data not shown).

Biological trends correlated with microarray data. In particular, the baseline levels (0 months-before treatment) of MHC-7β, TT2, and MLC2 appear to be significantly different between the R and NR (elevated in the R), and after the course of 12 months of treatment, these differences appeared to level out. CK, however, seemed to trend in the opposite direction with increasing difference in absolute native peptide quantities after treatment.

### Phosphorylation Data

### Analytic Techniques

Experiments were conducted to identify patterns of sarcomeric protein phosphorylation associated with a responsive or a non-responsive phenotype. One of the approaches included the use of Pro Q Diamond staining (a phosphoprotein stain with high sensitivity) to quantify total phosphorylation of myofibrillar proteins and 2D gel electrophoresis which provided isolation and separation of phosphospecies. Results (not shown) showed at least two putative phosphorylation sites on RLC (one at serine 15). Proteins were identified from the gel using an Offgel strategy (OGE, Agilent). This allowed the separation by pH and mol wt. of relatively large quantities of purified protein suitable for LS MS/MS analysis.

Using this strategy (followed by LS MS/MS) the second phosphorylation site in RLC2 at the adjacent serine, S16, was identified and the quantitative changes reflecting site specific and total phosphorylation of RLC in human models of disease were investigated.

### Analysis of Human Samples

Contractile protein phosphorylation patterns in tissue samples collected from the BORG study patients were analyzed. A phosphoprotein stained gel (ProQDiamond) and the companion convention gel were obtained. Total cell homogenates were analyzed, as opposed to a purified myofibrillar fraction, and Western blotting with phosphospecific antibodies was obtained. One non-responder (NR) and 2 responders (R) were contrasted (data not shown).

There was a clear increase in MLC2 phosphorylation in R versus NR as well as a general increase in overall kinase activity. TnI phosphorylation appeared to be slightly increased and this finding was confirmed by analyzing this protein using IEF.

A second study of human tissue was conducted involving aortic stenosis patients undergoing valve replacement who presented either with hypertrophy and preserved LV systolic function (hyp) or with LV dilation and a reduced ejection fraction (dil). Biopsies were taken at the time of valve replacement concurrent with cardioplegia and immediately flash frozen and stored in liquid nitrogen until analyzed. In biopsies from hyp, total troponin I (TnI) phosphorylation was markedly increased and myosin light chain 2 (MLC2) phosphorylation unchanged relative to a control group of patients with normal LV function. Conversely, in dil, TnI phosphorylation was significantly reduced compared to controls and MLC2 phosphorylation was increased. Myofilament bound protein phosphatase-1 was reduced in hyp and myofilament bound protein phosphatase-2 was reduced in dil.

Taken together these data showed that a limited and specific set of post-translational modifications of sarcomeric proteins both singly and in combination, were functionally significant and stage-specific and can be used to characterize patients with progressive left ventricular dysfunction and/or to predict clinical responsiveness. Exemplary proteins and sites identified for use as biomarkers include, but are not limited to, TnI (S22,23,S44,45, T143), MLC2 (S15,16), TnT (T206), and MyBP-C (S303).

These data show that mRNA, miRNA, and protein abundance and phosphorylation state can be selectively measured simultaneously in endomyocardial samples from the intact human heart. This comprehensive analysis of tissue obtained from an endomyocardial biopsy can be used as a predictive tool to allow the early identification of patients who will and will not respond to pharmacotherapy.

### Discussion

The present inventor has developed a predictive algorithm generated from the analysis of an existing cohort of 72 patients with dilated cardiomyopathy who have undergone serial endomyocardial biopsies before and after initiation of beta-blocker therapy. The outcome (or none responsiveness determination) is the combined endpoint of cardiac death, transplant life threatening arrhythmia, placement of a ventricular assist device, or failure of LVEF to improve on beta blocker (delta LVEF<5%) at one year. Some of the variables of the algorithm include, but are not limited to: (i) mRNA profiling; (2) miRNA array data evaluating specific miRNA that influence myocardial gene profiles; and (3) phosphoproteomic and target protein isoform changes that have been shown to predict and define stage-specific adaptations to pathologic pressure overload.

mRNA

Some of the experiments generated data from an initial cohort of 27 BORG patients utilizing Affymetrix U133 plus 2 arrays. The results in these 196 genes are validated in the subsequent 45 patients. In addition, other informative genes are identified for further testing. The Affymetrix array is commercially available. One aspect of the invention provides methods for a high-throughput assay for molecular biomarkers in endomyocardial biopsies. As discussed herein, statistical and bioinformatics analysis of the gene expression microarray data were used to identify informative transcripts that are useful in predicting responsive and non-responsive patients to the pharmacotherapy. A quantitative gene expression analysis was also developed via scalable, multiplexed PCR that offers a robust predictive tool that allows the early identification of patients who will and will not respond to pharmacotherapy.

In some experiments, Beckman Coulter GenomeLab™ GeXP Genetic Analysis System was used. This system provided high-throughput, quantitative gene expression analysis via scalable, multiplexed PCR. Up to 30 genes can be multiplexed in the same PCR reaction. This technology using unique priming strategy overcomes the biases that limit standard multiplexed PCR analysis to just a few genes at a time and delivers more genes per reaction and more samples per run, removing bottlenecks in gene expression studies for drug discovery and development research. Using this system, it is possible to run two 96-well plates in 24 hours, and analyze the expression of dozens of genes in a single reaction per well. This system is useful in working with smaller gene sets that can provide key information relating to biological state or response. This system operates at a fraction of the cost of a standard RT-PCR system and delivers highly accurate and quantitative results for hundreds or even thousands of samples using very small amounts of total RNA.

As discussed herein, some methods use commercial gene analysis systems such as Beckman Coulter GenomeLabTM GeXP Genetic Analysis System which employs eXpress Profiling (XP-PCR). Such a system can be used to analyze up to 30 genes simultaneously in the same reaction. The following is a brief description of each step of the method.

### GeXP Multiplex Primers Design

Two multiplex primer sets were designed to profile the informative gene transcripts (See Table below “Informative and control genes”) using GenomeLab GeXP eXpress Profiler software. Primers were designed to generate amplified products (130-350 bp) with similar GC content and melting temperature for each set. Each gene-specific primer had a proprietary 5′ universal primer added by the software. All primers were obtained from Integrated DNA Technologies and supplied at a stock concentration of 100 μM in 96-well microtiter plates.

TABLE
Informative and control genes.

| | Affymetrix Probe | |
|---|---|---|
| Entrez Gene Name | Set ID | Gene Symbol |
| phosphoinositide-3-kinase, catalytic, α polypeptide | 235980_at | PIK3CA |
| Aspartylglucosaminidase | 216064_s_at | AGA |
| ceroid-lipofuscinosis, neuronal 3 | 209275_s_at | CLN3 |
| neuro-oncological ventral antigen 1 | 205794_s_at | NOVA1 |
| sphingomyelin phosphodiesterase 1, acid lysosomal | 217171_at | SMPD1 |
| CD40 molecule, TNF receptor superfamily member 5 | 35150_at | CD40 |
| ATP-binding cassette, sub-family G (WHITE), member 2 | 209735_at | ABCG2 |
| laminin, gamma 2 | 202267_at | LAMC2 |
| phospholipase D1, phosphatidylcholine-specific | 215723_s_at | PLD1 |
| ATPase, Ca++ transporting, type 2C, member 1 | 209935_at | ATP2C1 |
| WW domain containing oxidoreductase | 210695_s_at | WWOX |
| ADAM metallopeptidase domain 9 (meltrin gamma) | 1570042_a_at | ADAM9 |
| inositol polyphosphate-4-phosphatase, type I, 107 kDa | 208363_s_at | INPP4A |
| G protein-coupled receptor kinase 5 | 204395_s_at | GRK5 |
| protein phosphatase 1, regulatory (inhibitor) subunit 3C | 240187_at | PPP1R3C |
| cytoglobin | 1553572_a_at | CYGB |
| ELOVL family member 6, elongation of long chain fatty | 204256_at | ELOVL6 |
| acids (FEN1/Elo2, SUR4/Elo3-like, yeast) | | |
| phospholipase D1, phosphatidylcholine-specific | 215723_s_at | PLD1 |
| protein kinase C, theta | 210038_at | PRKCQ |
| CD8a molecule | 205758_at | CD8A |
| disrupted in schizophrenia 1 | 230451_at | DISC1 |
| nudE nuclear distribution gene E homolog (A. nidulans)- | 227553_at | NDEL1 |
| like 1 | | |
| prostaglandin D2 receptor (DP) | 215894_at | PTGDR |
| troponin T type 3, (skeletal, fast) | 205693_at | TNNT3 |
| myosin X | 216222_s_at | MYO10 |
| collagen, type VIII, alpha 2 | 221900_at | COL8A2 |
| myosin, light chain 4, alkali; atrial, embryonic | 210088_x_at | MYL4 |
| myosin, heavy chain 7, cardiac muscle, beta | 216265_x_at | MYH7 |
| myosin, light chain 4, alkali; atrial, embryonic | 216054_x_at | MYL4 |
| myosin regulatory light chain MRCL3 | 201319_at | MRCL3 |
| thyroid receptor interacting protein 15 | 225421_at | PM20D2 |
| histone cluster | 208180_s_at | HIST1H4H |
| zinc finger and BTB domain containing 44 | 220243_at | ZBTB44 |
| G protein-coupled receptor 4 | 206236_at | CPR4 |
| guanine deaminase | 224209_s_at | GDA |
| exosome component 4 | 91684_g_at | EXOSC4 |
| mucolipin 3 | 1557292_a_at | MCOLN3 |
| neuroligin 1 | 231361_at | NLGN1 |
| splicing factor 1 | 210172_at | SF1 |
| chloride intracellular channel 6 | 227742_at | CLIC6 |
| iron-responsive element binding protein 2 | 1555476_at | IREB2 |
| dystrophin | 208086_s_at | DMD |
| vitronectin | 204534_at | VTN |
| alpha myosin heavy chain | 204737_s_at | MYH6 |
| sarcoplasmic reticulum calcium ATPase | 230693_at | ATP2A1 |

### Multiplex Reverse Transcription

First-strand cDNA was primed from total RNA (10 to 100 ng) using the gene-specific chimeric reverse primer mix, reverse transcriptase and buffers. The RT reaction was performed in a thermal cycler with the following program: 48° C. for 1 min; 37° C. for 5 min; 42° C. for 60 min; 95° C. for 5 min; hold at 4° C. 3.4.

### Multiplex PCR

An aliquot (9.3 μ) of the 20 μl RT reaction was transferred to the PCR reaction mix containing MgCl₂, the gene-specific forward chimeric primers, D4-labeled universal forward primer, unlabeled universal reverse primer and Thermo-Start DNA polymerase (ABgene). The 96-well plate containing the PCR reaction mixture was transferred to a thermal cycler and the following program was executed: 1 cycle of 95° C. for 10 min, 35 cycles at 94° C. for 30 sec, 55° C. for 30 sec, 70° C. 1 min; hold at 4° C. To avoid possible contamination from non-specific template sources during PCR, the GeXP RT and pre-PCR reactions were prepared in an UV-cabinet in a location physically separated from areas where PCR and post-PCR work was performed.

### Product Separation and Quantitation

D4-fluorescently-labeled PCR products were mixed with DNA size standard, and sample loading solution and overlaid with mineral oil. Products were separated based on size by capillary gel electrophoresis; dye signal was detected and signal strength was quantified by the GeXP system. The separation conditions on the GeXP system were as follows: capillary temperature 50° C., denaturation at 90° C. for 120 sec, injection for 30 sec at 2.0 kV, separation at 6.0 kV for 35 min.

### GeXP Multiplex Data Analysis

Once PCR products were separated the raw data were analyzed using default GeXP analysis parameters. The fragment data, including size, peak height and peak area were imported to Microsoft Excel for predicted size comparison and normalization to internal standards for relative expression determination. PCR product sizes were determined to identify each transcript.

The same samples for mRNA expression profiling were subjected to profiling of miRNAs (MiRBase v10.1) using the Dharmacon array platform with an external reference library. All data processing were undertaken in R 2.8.1. Extensive preprocessing and filtering of miRNA data were performed. Array data were processed and normalized (RMA) using the affy, simpleaffy and annaffy R packages from BioConductor version 2.3.10. Probe sets were mapped to official gene symbols using aafSymbol, and probe sets lacking a gene symbol were removed. Only probes with <50% of their calls determined as absent (A) were retained; when multiple probes were mapped to a single gene, the median expression value was taken. The sequence based target prediction matrix “C” was created by downloading the “Conserved_Family_Conserved_Targets_Info” and “miR_Family_Info” files form TargetScanS (v5.0) and modified to include only those miRNAs and mRNAs expressed in the heart biopsies. Likewise, miRNAs and mRNAs in the expression set but absent from the C matrix were removed. The dataset was reduced to possible target-pair interactions that were scored by GenMiR++, which is a Bayesian Network program of probabilistic modeling. Target pairs underwent further analysis including “GO term” enrichment analysis (frequency of both ‘biological process’ and ‘molecular function’ ontology terms) to identify overrepresentation of biological concepts. The identification of Gene Ontology (GO) term enrichment utilized the GOstat web application with the human background database (goa_human). The Database for Annotation, Visualization and Integrated Discovery (DAVID) [URL: http://david.abcc.ncifcrf.gov/] were also used to filter the high-scoring interaction pairs and explore biological meaningfulness of these miRs. The process of analyzing miR/mRNA co-expression is illustrated in FIG. 5.

### Experimental Overview

Selected samples from the BORG cohort were evaluated which involved serial biopsies in subjects with newly diagnosed dilated cardiomyopathy before and after treatment with beta-blocker therapy. This serial biopsy strategy allowed identification of contractile protein abnormalities that characterize left ventricular dysfunction and that were altered following clinical recovery (i.e., reversal).

Biochemical measurements were designed to identify relevant proteomic changes associated with heart failure that predict a response to therapy. To do this: (1) global changes in phosphorylation of the myofilament proteins were identified; (2) the sites of phosphorylation were identified; (3) changes in myofilament protein isoform composition were identified; and (4) changes in stoichiometry of the myofilament and associated proteins were quantified. These parameters were examined from the protein generated from a single biopsy. This allowed examination of protein modifications in the same heart that was being used to examine changes in RNA, microRNAs and DNA. Global changes in protein phosphorylation were examined using SDS-PAGE and phosphospecific staining with Pro Q Diamond gel stain. Pro Q Diamond gel stain provided a method of selectively identifying phosphorylated proteins in a sample without using radioactivity. After imaging and documentation, the same gels were stained with colloidal Coomassie blue gel stain (BioRad), which provided detection of protein in the nanogram range (similar to silver stain) and was linear over 3 orders of magnitude. Gels were imaged on a ChemiDoc System (BioRad), which uses a supercooled CCD camera. Changes in phosphorylation of a given protein were measured as a ratio of phosphoprotein (a.u.)/total protein (a.u.).

Site-specific phosphorylation of troponin I, troponin T and myosin binding protein C were determined, in part, by western blotting with phosphospecific antibodies. Some of the antibodies that are available include, but are not limited to, Troponin I; phosphoS22/23 (Fitzgerald), phosphoS43 (Fitzgerald), phosphoT144 (Fitzgerald); and a PKC phosphosubstrate antibody (Cell Signaling) which recognizes phosphoS302 on MyBPC. Additional phosphospecific antibodies were generated. The OFFGEL fractionation system (Agilent) separated proteins according to their isoelectric point (thus separating charge species such as phosphoproteins) while the proteins were maintained in solution. The fractions were easily recovered and relatively abundant proteins were processed further for mass spectrometry. This approach allowed analysis of phosphorylation sites in proteins that were otherwise challenging to separate either due to their large size (i.e., myosin and myosin binding protein C) or their charge (i.e., troponin I) and was far superior to 2-D gel fractionation which requires in-gel digestion and removal of the protein from the gel, which results in sample loss and decreases the likelihood of robust identification.

### 2D Gel Analysis

Myofilament fractions were separated according to charge by isoelectric focusing over a non-linear pH gradient consisting of ampholytes pH 3-10 and 4.0-6.5 mixed in a 1:5 ratio respectively (Amersham Pharmacia Biotech). Similar amounts of protein (based on w/v) were loaded in each tube, however an accurate determination of protein concentration was difficult and therefore, description of changes in the proteome were ratiometric. After isoelectric focusing, the proteins were separated by molecular weight and the gels stained with Pro-Q Diamond phosphoprotein stain (Molecular Probes) and visualized on a Typhoon 9410 (GE Healthcare). Once examination of the total myofilament proteome has been completed, further separation of spot clusters were accomplished by running micro-range pI gradients with higher or lower percentage separating gels depending on the pI and molecular weight of the clusters. For example, Troponin T (TnT) isoform expression and phosphorylation were analyzed on immobilized pH gradient (IPG) strips with a narrower pH range (4.7-5.9) for the first dimension separation (to resolve phosphorylated species). This strategy allowed separation of the 4 splice variants of TnT, each with multiple phosphorylation sites. High resolution 2-D PAGE allowed determination of the expression levels of each splice variant and their phosphorylation status. The same general strategy was applied to other proteins, with subsequent Western blotting to confirm protein and phosphoprotein identification.

### OGE Fractionation

For OFFGEL fractionation, myofilament fractions were diluted in OFFGEL electrophoresis buffer (7M urea, 2 M thiourea, 6% glycerol, 65 mM DTT, and 1% ampholytes. Up to 4 mg total protein extract were loaded for each run, allowing separation and isolation of proteins for mass spec analysis.

### Quantification

2-dimensional gels were quantified using BioRad's PDQuest 2-D analysis software. Briefly, proteins that change either expression level or phosphorylation level were quantified relative to a minimum of two other proteins. Furthermore, to get more accurate absolute quantification, samples from 6-8 specimens from an individual group were pooled and homogenized. This allowed examination of the subproteome in each grouped sample relative to one another, rather than using normalized data. These gels were used to verify changes found ratiometrically.

### Troponin I Phosphorylation

Two parallel strategies were adopted to investigate this feature of TnT protein modification: non-equilibrium isoelectric focusing and western blotting with phosphospecific antibodies. The former strategy was useful because of the extremely basic nature of the native protein, which prevents clear separation on conventional 2D gels. Samples were loaded on a 4.5% acryl amide slab gel with a non-linear pH gradient made with a 1:4 ratio of 3-10 ampholytes and 7-9 ampholytes. The cathode and anode buffers and the polarity of the electrodes were then reversed and proteins were separated at 100 V for 20 min, 200 V for 40 min and 500 V for 10 min. Proteins were then transferred to PVDF membranes, incubated with site-specific anti-phosphoTnl antibodies and visualized with enhanced chemiluminescence. To evaluate whether in vivo proteolysis of TnI might have occurred, antibodies specific for both the amino and carboxy terminal of the protein were employed.

Multiplexed SRM assays were developed to rapidly assess the predictive utility of each of the BORG candidate protein biomarkers (including phosphorylated protein isoforms). Unique tryptic peptides (unmodified and/or phosphorylated) were selected for each targeted protein from the primary amino acid sequence. Synthetic peptides were acquired for each candidate peptide and used for characterization of retention time during chromatographic separation on reversed phase material (40 cm Aqua C18 μLC column, 75 μm inner diameter, 5 μm tip, Phenomenex), validation of MS/MS fragmentation pattern, optimization of μLC and verification of SRM transition within the biological matrix using standard addition experiments. Standard addition experiments (sample load: synthetic peptide and human heart explant protein digest) were used to determine whether any matrix ion suppression effects was present due to the heart protein digest matrix [i.e. the peptide of interest (precursor ion) and/or any of the product ions were masked by signals from co-eluting ions within the sample]. Chromatographic conditions were optimized while monitoring the TIC of each transition. All chromatographic analyses were limited to 60-120 minutes. Unique peptides that cannot be optimized chromatographically for SRM (e.g., due to unresolved matrix ion suppression issues) were pursued.

Intense transitions were selected from each unique tryptic peptide and multiplexed into one time-scheduled SRM assay. This facilitated the development of assay panels inclusive of proteins involved in functional clusters. Stable isotope-labeled versions of peptides selected for multiplexing were acquired and added to each sample for absolute quantification. In some instances, multiplexed SRM assays for 50 peptides per assay were developed. In other instances, assays were developed for the 196 genes found to be differentially expressed in mRNA analyses and for phosphorylated targets discovered in phosphoproteomic analyses.

### Statistical Analysis and Power Calculations

Machine Learning with Multi-Level Heart Failure Data

Novel machine learning and bioinformatics methods were utilized for discovering biomarkers in multi-level data that were predictive of heart failure risk and outcome. These methods were developed using data collected with the aim being to develop classifiers for stratifying patients into high-versus low-risk groups. The machine learning methods were specifically designed to address at least two issues—(i) dimensionality and complexity and (ii) interpretability—in applying statistical learning methods to high-dimensional dimensional biomedical data sets. High-throughput profiling data sets captured enormous information with thousands of variables (p) at multi-level of biological systems and processes. However, typical sample sizes (n) remained relatively small, especially in the context of heart failure patients. The number of features involved in the classifiers ranged from tens to hundreds including, but not limited to, interpreting, validating, implementing and translating these classification rules to the clinic.

### Novel Comparison-Based Classification Method

Previously, the present inventor had developed a novel comparison-based method, k-TSP (k-disjoint Top Scoring Pairs), to directly address the tradeoff between sample size and model complexity as well as between “bias-variance” by incorporating simplifying assumptions. This method discriminates disease classes by finding pairs of genes (or proteins or miRNAs) whose expression levels typically invert from one class to the other. This approach has been demonstrated to be: (a) robust to quantization effects; (b) allow direct data integration from multiple studies; (c) invariant to data pre-processing methods, such as normalization, under very mild assumptions; and (d) achieved comparable or exceeds other machine learning methods in classifying high-throughput biomedical data. The gene pair comparisons can be easily interpreted as IF-ELSE decision rules. These gene pairs were validated by RT-PCR and facilitated the translational research for patient stratification.

### Extensions to Multi-Level Data Integration

This comparison-based approach in learning multi-level data was extended to: gene expression (HG_U133 Plus 2.0 platform, Affymetrix, Inc.), miRNA expression (Dharmacon, Inc.), protein expression and phosphorylation data. For each individual platform, k-TSP was used to identify gene pairs (or protein pairs or miRNA pairs) that can discriminate between high- and low-risk groups. Using the feature pairs derived from each platform, a decision tree was induced that integrated these various multi-level features to make prediction. This integration represented an ensemble learning approach, where the base classifiers were k-TSP feature pairs from individual platforms. The prediction was tested and validated using cross-validation strategy. All of the feature pairs were validated by experimental techniques before implementing them in the clinic. Publicly available data (e.g., CardioGenomics http://cardiogenomics.med.harvard.edu) were also collected to test the predictive power of this classifier. In some instances, these public data sets were also included in the learning process.

In some cases, the sample size calculations were derived from the analysis of the data. The primary endpoint (or determination of none responsive patient) was a composite of cardiac death, transplantation, life threatening ventricular arrhythmias, or failure to improve EF by 5 units at one year. An analysis of mRNA data was conducted in BORG utilizing PowerAtlas. The EDR is the proportion of genes that are truly differentially expressed that are called significant at the chosen significance level. This is analogous to average power. The smaller the significance level is, the lower the EDR. Increasing the sample size increases the EDR. For example, assuming a 20% non-response rate, a clinical trial of approximately 100 patients would be necessary to obtain 20 patients who are non-responders. At a p-value equal to 0.01, a 100 patient study has an EDR of approximately 95%.

### Human Subjects Involvement and Characteristics

This study involved a retrospective analysis of tissue collected previously in the BORG trial. The BORG trial was a multi-center study evaluating the effects of beta-blockade on myocardial gene expression. The patients in this database had idiopathic dilated cardiomyopathies, NYHA class II-IV symptoms of heart failure and ranged in age from 21 to 72 years.

The inclusion and exclusion criteria for the BORG trial were as follows: Inclusion Criteria: (1) Patients with idiopathic dilated cardiomyopathy had symptoms of New York Heart Association (NYHA) Class II, III or IV congestive heart failure (CHF) at the time of randomization. Left ventricular diastolic diameter index (LVIDd) was greater than 3.0 cm/m as measured by two-dimensional echocardiography (2-D Echo). Patients had a coronary arteriogram performed within at least two years of enrollment that did not exhibit occlusive (>50% narrowing of any major epicardial coronary artery) and were free of a clinical history consistent with coronary artery disease (CAD); (2) Patients were age 18 or older and were of either gender and of any race; (3) Women of child bearing potential who were not surgically sterile must have had a negative serum pregnancy test and were using a reliable method of contraception; (4) IDC patients were on optimal conventional therapy, including angiotensin converting enzyme inhibitor (ACEi) for at least 3 weeks prior to baseline assessment of key study endpoints, or patients must have had a trial of ACEi and had been proven to be intolerant; (5) Patients had a left ventricular ejection fraction (LVEF) of 0.40 determined by radionuclide ventriculography (RVG) within sixty days of randomization (Treatment Day 1); (6) Patients demonstrated the mental and physical ability and willingness to follow all study specific instructions and procedures; and (7) Patients were competent to give informed written consent. Exclusion Criteria: (1) Patients did not have heart failure due to or associated with uncorrected primary valvular disease, uncorrected thyroid disease, obstructive/hypertrophic cardiomyopathy, pericardial disease, amyloidosis, active myocarditis, or malfunctioning artificial heart valve; (2) Heart transplant candidates (actively on a list or anticipated to be on a list within 6 months of randomization) were excluded; (3) The following patients were also excluded because of current medications they were receiving: (a) IDC patients receiving calcium channel blocking agents, theophylline, tricyclic antidepressants, MAO inhibitors, or beta-agonists that could not be safely withdrawn from such. IDC patients taking oral beta-adrenergic blocking agents within 30 days of baseline assessment of key study endpoints; (b) IDC patients taking oral alpha-adrenergic blocking agents within 30 days of baseline assessment of key study endpoints; (c) IDC patients on investigational cardiovascular medications or involved in another investigational trial; (d) Patients taking flecainide, encainide, propafenone, sotalol, or disopyramide within 2 weeks of randomization or amiodarone within 8 weeks; and (e) Patients on an intravenous or oral inotrope (other than digitalis) within 2 weeks of baseline assessment of key study endpoints (see below); (4) The following patients were also excluded for medical reasons: (a) IDC patients with a contraindication to beta-adrenergic blockade (e.g. asthma); (b) IDC patients with other life threatening disease with a life expectancy<2 years due to other illness; (c) IDC patients with active hepatic (total bilirubin >3.0 mg %), renal (creatinine 3.0 mg %), hematologic, gastrointestinal, immunologic, endocrine, metabolic, or central nervous system disease which, in the opinion of the investigator, may adversely affect the safety and efficacy of the study drug or the life span of the patient; (d) Patients with unstable decompensated heart failure (e.g., evidence of hypoperfusion, acute pulmonary edema, or hypotension with systolic BP<90 mmHg); (e) Patients actively abusing ethanol or illicit drugs within 3 months of randomization. Abuse of alcohol is defined as the usual daily intake of more than 100 gms of ethanol per day, or more than approximately six twelve-ounce bottles of beer, one 750 ml bottle of wine or 250 ml of 90 proof spirits; (f) Patients with an AICD that has fired within 3 months of randomization; (g) Asymptomatic waking, resting heart rate<50 BPM, or symptomatic bradycardia with heart rate <60 BPM; (h) Uncontrolled insulin-dependent diabetes mellitus with a history of frequent hypoglycemia episodes; (i) High degree atrioventricular block (Mobitz II or complete heart block); and (j) Patients unable to undergo the MRI procedures required in this study (e.g. having a pacemaker, intra-ocular or intracranial clips or foreign bodies, recent surgical clips or whose obesity may prevent them from fitting into MRI machine); and (5) Demonstrated non-compliance with previous medical regimens.

The foregoing discussion of the invention has been presented for purposes of illustration and description. The foregoing is not intended to limit the invention to the form or forms disclosed herein. Although the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

1. A method for determining whether a congestive heart failure patient will respond to a pharmacotherapy treatment, said method comprising determining the expression level of at least ten selected biomarker genes from a biological sample obtained from a congestive heart failure patient, wherein the selected biomarker genes are chosen from a panel of standard biomarker genes that are upregulated or downregulated in a heart failure patient that responds to the pharmacotherapy compared to a heart failure patient that does not respond to the pharmacotherapy, wherein if the expression level of the selected biomarker genes in the biological sample of the patient is statistically more similar to the expression level of the biomarker genes that has been associated with the heart failure patient that responds to the pharmacotherapy than the expression level of the biomarker genes that has been associated with the heart failure patient that does not respond to the pharmacotherapy, then the result is indicative that the patient responds to the pharmacotherapy.

2. The method of claim 1, wherein the panel of standard biomarker genes comprises AGK, BCL2L13, COQ10B, HIF1AN, PPM1D, SPCS3, TBL1XR1, TBX2, TMEM139, UBE2B, ATP6V1B2, ATRNL1, C10orf88, CAPZA2, CASQ1, CDK5R1, CENPQ, CETP, COX8A, DGAT1, ERCC4, ERF, FPGT, GLS, IRF2, LEMD3, MAGEE1, ME2, MSX2, NHEDC2, NUFIP2, PABPC1L, PCDHB15, PDIA6, PHF2, PLEKHA3, PPIC, PRPF38B, RAP2B, RBM12B, RFXAP, ROBO4, SMAD4, SMNDC1, SOAT1, SPINT2, TM2D1, VTN, WDR44, XPNPEP3, ZNF704, ADRB1, ANKIB1, ARHGEF15, ARMC1, ASXL2, ATP6V1A, BBS10, BET1, BHLHE40, Cl4orf2l, Cl6orf87, Clorf55, C2orf37, C5orf22, C6orf59, CA3, CASD1, CTDSPL2, EDEM3, EGLN3, EPB41L5, ERO1L, FAM117B, FAM26E, GALNTL1, GIPC2, HK2, HOXD3, HPRT1, IMMP1L, ISCA1, KCNJ2, KDSR, KIAA0562, KIAA0802, LOC148189, LRRC40, LYRM5, MEX3C, MRPS25, NDFIP1, NETO2, PLN, SLAIN2, SLC16A7, SLC17A5, SPATA5, TMEM19, TMEM65, UGDH, UNC5B, ZBTB44, ZC3H12C, ZCCHC2, ZDBF2, ZNF404, and ZNF791.

3. The method of claim 1, wherein the selected biomarker gene comprises AGK, BCL2L13, COQ10B, HIF1AN, PPM1D, SPCS3, TBL1XR1, TBX2, TMEM139, UBE2B, or a combination thereof.

4. The method of claim 3, wherein the selected biomarker gene further comprises ATP6V1B2, ATRNL1, C10orf88, CAPZA2, CASQ1, CDK5R1, CENPQ, CETP, COX8A, DGAT1, ERCC4, ERF, FPGT, GLS, IRF2, LEMD3, MAGEE1, ME2, MSX2, NHEDC2, NUFIP2, PABPC1L, PCDHB15, PDIA6, PHF2, PLEKHA3, PPIC, PRPF38B, RAP2B, RBM12B, RFXAP, ROBO4, SMAD4, SMNDC1, SOAT1, SPINT2, TM2D1, VTN, WDR44, XPNPEP3, ZNF704, or a combination thereof.

5. The method of claim 4, wherein the selected biomarker gene further comprises ADRB1, ANKIB1, ARHGEF15, ARMC1, ASXL2, ATP6V1A, BBS10, BET1, BHLHE40, Cl4orf2l, Cl6orf87, Clorf55, C2orf37, C5orf22, C6orf59, CA3, CASD1, CTDSPL2, EDEM3, EGLN3, EPB41L5, ERO1L, FAM117B, FAM26E, GALNTL1, GIPC2, HK2, HOXD3, HPRT1, IMMP1L, ISCA1, KCNJ2, KDSR, KIAA0562, KIAA0802, LOC148189, LRRC40, LYRM5, MEX3C, MRPS25, NDFIP1, NETO2, PLN, SLAIN2, SLC16A7, SLC17A5, SPATA5, TMEM19, TMEM65, UGDH, UNC5B, ZBTB44, ZC3H12C, ZCCHC2, ZDBF2, ZNF404, ZNF791, or a combination thereof.

6. The method of claim 1, wherein the expression level of at least twenty selected biomarker genes are determined and compared to the control expression level.

7. The method of claim 6, wherein the expression level of at least fifty selected biomarker genes are determined and compared to the control expression level.

8. The method of claim 7, wherein the expression level of at least sixty selected biomarker genes are determined and compared to the control expression level.

9. The method of claim 1, wherein said method comprises determining the expression level of mRNA of the selected biomarker genes.

10. The method of claim 9, wherein said method further comprises determining the expression level of miRNA that inhibits or accelerates translation mRNA.

11. The method of claim 10, wherein miRNA comprises miRNA-1, miRNA-21, miRNA-29, miRNA-133a, miRNA-133b, miRNA-150, miRNA-195, miRNA-208, or a combination thereof.

12. The method of claim 10, wherein said method further comprises determining the ratio of expression levels of mRNA and miRNA.

13. The method of claim 10, wherein said method further comprises determining the amount of protein produced by the selected biomarker gene.

14. The method of claim 1, wherein the sample comprises an endomyocardial biopsy sample of the patient.

15. A microarray comprising a plurality of oligonucleotides that are capable of detecting expression level of at least ten biomarker genes selected from the group consisting of AGK, BCL2L13, COQ10B, HIF1AN, PPM1D, SPCS3, TBL1XR1, TBX2, TMEM139, UBE2B, ATP6V1B2, ATRNL1, C10orf88, CAPZA2, CASQ1, CDK5R1, CENPQ, CETP, COX8A, DGAT1, ERCC4, ERF, FPGT, GLS, IRF2, LEMD3, MAGEE1, ME2, MSX2, NHEDC2, NUFIP2, PABPC1L, PCDHB15, PDIA6, PHF2, PLEKHA3, PPIC, PRPF38B, RAP2B, RBM12B, RFXAP, ROBO4, SMAD4, SMNDC1, SOAT1, SPINT2, TM2D1, VTN, WDR44, XPNPEP3, ZNF704, ADRB1, ANKIB1, ARHGEF15, ARMC1, ASXL2, ATP6V1A, BBS10, BET1, BHLHE40, Cl4orf2l, Cl6orf87, Clorf55, C2orf37, C5orf22, C6orf59, CA3, CASD1, CTDSPL2, EDEM3, EGLN3, EPB41L5, ERO1L, FAM117B, FAM26E, GALNTL1, GIPC2, HK2, HOXD3, HPRT1, IMMP1L, ISCA1, KCNJ2, KDSR, KIAA0562, KIAA0802, LOC148189, LRRC40, LYRM5, MEX3C, MRPS25, NDFIP1, NETO2, PLN, SLAIN2, SLC16A7, SLC17A5, SPATA5, TMEM19, TMEM65, UGDH, UNC5B, ZBTB44, ZC3H12C, ZCCHC2, ZDBF2, ZNF404, and ZNF791.

16. The microarray of claim 15, wherein said microarray is capable of detecting the expression of at least twenty biomarker genes.

17. The microarray of claim 15, wherein said microarray is capable of detecting the expression of at least fifty biomarker genes.

18. The microarray of claim 15, wherein said microarray is capable of detecting the expression of at least sixty biomarker genes.

19. The microarray of claim 15, wherein said microarray is capable of detecting the expression level of biomarker genes comprising AGK, BCL2L13, COQ10B, HIF1AN, PPM1D, SPCS3, TBL1XR1, TBX2, TMEM139, UBE2B, or a combination thereof.

20. The microarray of claim 15, wherein said microarray is further capable of detecting the expression level of biomarker genes comprising ATP6V1B2, ATRNL1, C10orf88, CAPZA2, CASQ1, CDK5R1, CENPQ, CETP, COX8A, DGAT1, ERCC4, ERF, FPGT, GLS, IRF2, LEMD3, MAGEE1, ME2, MSX2, NHEDC2, NUFIP2, PABPC1L, PCDHB15, PDIA6, PHF2, PLEKHA3, PPIC, PRPF38B, RAP2B, RBM12B, RFXAP, ROBO4, SMAD4, SMNDC1, SOAT1, SPINT2, TM2D1, VTN, WDR44, XPNPEP3, ZNF704, or a combination thereof.

21. (canceled)
